(19) United States
(12) Patent Application Publication
(10) Pub. No.: US 2026/0060482 A1
(43) Pub. Date: Mar. 5, 2026

(54) SOAP HOLDING APPARATUS AND ASSOCIATED METHODS OF MANUFACTURE AND USE

(71) Applicant: HYHY Incorporated, Sheridan, WY (US)

(72) Inventor: Paul Leendertse, Vittoria (CA)

(21) Appl. No.: 19/277,483

(22) Filed: Jul. 23, 2025

Related U.S. Application Data
(63) Continuation-in-part of application No. 18/821,149, filed on Aug. 30, 2024.
(63) Continuation-in-part of application No. PCT/US25/38020, filed on Jul. 17, 2025.

(51) Int. Cl. A47K 5/04; F16M 11/24

(52) U.S. Cl. CPC A47K 5/04; F16M 11/24

(57) ABSTRACT

Disclosed is a soap holding apparatus and associated methods of manufacture and use. According to one embodiment, a soap holding apparatus includes an angled post. The soap holding apparatus includes a plurality of suspension arms affixed laterally on the angled post to hold the bar of soap. The plurality of suspension arms includes a first segment that laterally affixes each of the plurality of suspension arms to the angled post. The plurality of suspension arms includes a second segment extending from a distal end of the first segment at an obtuse angle. The soap holding apparatus includes a short lean arm laterally affixed to the angled post above the suspension arms to support the bar of soap. The soap holding apparatus includes a long lean arm laterally affixed to the angled post above the short lean arm to support the bar of soap.

### CLAIM OF PRIORITY

This Application is a Continuation-In-Part Application of, claims priority to, and incorporates by reference herein the entirety of the disclosure of U.S. Utility patent application Ser. No. 18/821,149 titled SOAP HOLDING APPARATUS AND ASSOCIATED METHODS OF MANUFACTURE AND USE filed on Aug. 30, 2024, and further claims priority to and incorporates by reference herein the entirety of the disclosure of the PCT Application No. PCT/US25/38020 titled SOAP HOLDING APPARATUS AND ASSOCIATED METHODS OF MANUFACTURE AND USE filed on Jul. 17, 2025.

### FIELD OF TECHNOLOGY

This disclosure relates generally to toiletry accessories and, more particularly, to a soap bar holding apparatus device and associated methods of manufacture and use.

### BACKGROUND

A soap holder may be an apparatus designed to hold and/or store a bar of soap. The soap holder may be used as a designated area to keep soap between uses. The soap holder may be made from various materials including but not limited to plastic, metal, ceramic, and/or wood. The soap holder may be mounted on walls, placed on countertops, and/or integrated into shower fixtures. The soap holder may not only serve a practical purpose but also add a decorative element to a bathroom and/or kitchen.

Soap holders may accumulate soap residue, water, and/or scum, which may make the soap holders inconvenient, unclean, unattractive, messy, and/or hard to clean. An unclean soap holder may inturn create a breeding ground for bacteria while reducing soap hygiene. If the soap holder lacks adequate drainage, water may hold on the holder's surface and may allow water to pool at the bottom, and/or allow water to accumulate on the soap holder's surface contact points. The soap may become soggy and/or dissolve faster due to the excess water and lack of drying. Some soap holders may be too small to hold larger bars of soap and/or soap that shrinks from use. Lightweight and/or poorly designed holders may tip over easily, which may cause the soap to fall out. Depending on the material, the soap holders may corrode, rust, and/or degrade over time with frequent water exposure and may cause allergic reactions in individuals and/or users. Some designs of the soap holders may not hold the soap securely, which may cause the soap to slip out easily and may be inconvenient.

Wall-mounted soap holders may cause damage to tiles and/or walls if not installed correctly. Adhesive soap holders may also leave a sticky residue and/or damage surfaces when removed. Wall-mounted magnetic soap holders may secure the soap by attaching a magnet to the bar of the soap and may exhibit limited compatibility with certain materials and/or soap types and/or cause metal components to rust. The magnet within the soap may cause the soap to crack and/or break and may not always hold the soap securely as the soap gets smaller. The magnet itself may be uncomfortable to hold when attached to the soap and may be uncomfortable on the body when using the soap it is attached to.

As such, soap may be wasted and/or used less frequently and/or effectively, which may lead to wasted money and the spread of germs, potentially harming users and their homes.

### SUMMARY

Disclosed are a method, a device and/or a system of soap holding apparatus and associated methods of manufacture and use.

In one aspect, a soap holding apparatus includes an angled post. The angled post includes an angled lower end, an uppermost edge, and a free end, the angled post affixed to a base drip tray. The soap holding apparatus includes a plurality of suspension arms affixed laterally on the angled post to hold the bar of soap. Each of the plurality of suspension arms is divided into two segments. Each of the plurality of suspension arms includes a first segment that laterally affixes each of the plurality of suspension arms to the angled post. Each of the plurality of suspension arms includes a second segment extending from a distal end of the first segment at an obtuse angle. The soap holding apparatus includes a short lean arm laterally affixed to the angled post above the suspension arms to support the bar of soap. The soap holding apparatus includes a long lean arm laterally affixed to the angled post above the short lean arm to support the bar of soap.

The base drip tray may be divided into a plurality of thirds, the plurality of thirds includes a front third, a middle third, and a rear third. The angled post may be affixed within the rear third of the base drip tray. The angled post may be angled backward of the base drip tray. The angled post may be angled toward an outermost edge of the rear third of the base drip tray.

The soap holding apparatus further includes an auxiliary angled post. The auxiliary angled post includes a second uppermost edge and a second free end. The auxiliary angled post may be connected to the angled post via a post connector, the post connector includes a groove, the groove formed on a bottom side of the post connector. The groove is configured to securely attach to the free end of the angled post. The plurality of second suspension arms laterally affixed to the auxiliary angled post. Each of the plurality of second suspension arms is divided into two segments. Each of the plurality of second suspension arms includes a first segment that laterally affixes each of the plurality of second suspension arms to the auxiliary angled post. Each of the plurality of second suspension arms includes a second segment extending from a second distal end of the first segment at a second obtuse angle. A second short lean arm laterally affixed to the auxiliary angled post above the plurality of second suspension arms. A second long lean arm laterally affixed to the auxiliary angled post above the second short lean arm.

In another aspect, a soap holding apparatus includes an extended angled post extending from a base drip tray. The soap holding apparatus includes a plurality of suspension arms affixed laterally on the extended angled post to hold a bar of soap. Each of the plurality of suspension arms is divided into two segments. Each of the plurality of suspension arms includes a first segment that laterally affixes each of the plurality of suspension arms to the extended angled post. Each of the plurality of suspension arms includes a second segment extending from a distal end of the first segment at an obtuse angle. The soap holding apparatus includes a short lean arm laterally affixed to the extended angled post above the suspension arms to support the bar of soap. The soap holding apparatus includes a long lean arm laterally affixed to the extended angled post above the short lean arm to support the bar of soap. The soap holding apparatus includes a plurality of second suspension arms laterally affixed to the extended angled post. Each of the plurality of second suspension arms is divided into two segments. Each of the plurality of second suspension arms includes a first segment that laterally affixes each of the plurality of suspension arms to the extended angled post. Each of the plurality of suspension arms includes a second segment extending from a second distal end of the first segment at a second obtuse angle. The soap holding apparatus includes a second short lean arm laterally affixed to the extended angled post above the plurality of second suspension arms. The soap holding apparatus includes a second long lean arm laterally affixed to the extended angled post above the second short lean arm.

The base drip tray may be divided into a plurality of thirds, the plurality of thirds includes a front third, a middle third, and a rear third. The angled post may be affixed within the rear third of the base drip tray. The angled post may be angled backward of the base drip tray. The angled post may be angled toward an outermost edge of the rear third of the base drip tray. The base includes a plurality of legs extending outwardly from the lower end of the angled post to support the soap holding apparatus.

In another aspect, a soap holding apparatus includes a vertical post. The vertical post includes an uppermost edge, a free end, a lower end, a plurality of holes, and/or a threaded hole. The soap holding apparatus includes a base removably attached to the lower end of the vertical post. The soap holding apparatus includes a plurality of suspension arms removably attached to the vertical post to hold a bar of soap. The soap holding apparatus includes a short lean arm removably attached to the vertical post above the suspension arms to support the bar of soap. The soap holding apparatus includes a long lean arm removably attached to the vertical post above the short lean arm to support the bar of soap.

The suspension arms, the long lean arm, and/or the short lean arm may be removably attached to a plurality of insert holes. The plurality of holes may include a top insert hole, a middle insert hole, and/or a plurality of bottom insert holes to affix the long lean arm, the short lean arm, and/or the plurality of suspension arms respectively. The short lean arm may be removably attached to the top insert hole using friction, screw, and/or snap mechanism. The long lean arm may be removably attached to the middle insert hole using friction, screw and/or snap mechanism. The plurality of suspension arms may be removably attached to the plurality of bottom insert holes using friction, screw, and snap mechanism. The base includes a base drip tray to collect water dripping from the bar of soap when the bar of soap may be held by the plurality of suspension arms. The base includes a plurality of legs extending outwardly to support the soap holding apparatus. The base may be removably attached to the vertical post by a screw, a peg-and-docket, a hook-and-loop, a screw-on mechanism, and/or a magnetic connection.

In yet another aspect, a soap holding apparatus includes a vertical post extending from a base. The vertical post includes a free end at an uppermost edge and a lower end. The soap holding apparatus includes a hinge connecting the vertical post to the base. The soap holding apparatus includes soap holding apparatus includes a plurality of suspension arms removably attached to the vertical post to hold a bar of soap. The soap holding apparatus includes a short lean arm removably attached to the vertical post above the suspension arms to support the bar of soap. The soap holding apparatus includes a long lean arm affixed detachably to the vertical post above the short lean arm to support the bar of soap.

The hinge allows the vertical post to pivot between upright and/or folded positions. The hinge may be configured to lock the vertical post in upright position. The vertical post includes a plurality of insert holes for attachment of the plurality of suspension arms, the short lean arm, and/or the long lean arm. The base includes a base drip tray to collect water dripping from the bar of soap when the bar of soap may be held by the plurality of suspension arms. The base includes a plurality of legs extending outwardly to support the soap holding apparatus.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is an apparatus view of a soap holding apparatus illustrating the components forming the apparatus, according to one or more embodiments.

FIG. 2 is a conceptual view of the soap holding apparatus of FIG. 1 illustrating a large bar of soap placed on suspension arms with the top of the soap leaning against the long lean arm, according to one or more embodiments.

FIG. 3 is another conceptual view of the soap holding apparatus FIG. 1 illustrating the method of holding a medium bar of soap placed on suspension arms with the top of the soap leaning against the short lean arm, according to one or more embodiments.

FIG. 4 is a conceptual view of the soap holding apparatus FIG. 1 illustrating a small bar of soap placed on the suspension arms, according to one or more embodiments.

FIG. 5A-5B is an apparatus view of a wall mounted soap holding apparatus illustrating the constituting components forming the wall mounted soap holding apparatus, according to one or more embodiments.

FIG. 6A-6B is an apparatus view of forming the wall-mounted soap holding apparatus of FIG. 5 to mount on the vertical surface, according to one or more embodiments.

FIG. 7 is an apparatus view of the soap holding apparatus of FIG. 1 illustrating the drip tray attached to the lower end of the vertical post to serve as a base, according to one or more embodiments.

FIG. 8 is the conceptual view of the soap holding apparatus of FIGS. 1-7 installed in different areas of a bathroom environment, according to one or more embodiments.

FIG. 9 is an apparatus view of the soap holding apparatus illustrating the components forming the apparatus, according to one or more embodiments.

FIG. 10A-10B is an apparatus view of the soap holding apparatus illustrating the components forming the apparatus, according to one or more embodiments.

FIG. 11 is a conceptual view of the soap holding apparatus, according to one embodiment.

FIGS. 12A-12B-12C are an apparatus view showing a plurality of base options of the soap holding apparatus, according to one embodiment.

FIG. 13 is a conceptual view of the soap holding apparatus, according to one embodiment

FIG. 14 is a dimensional view of the soap holding apparatus showing vertical post height, the length of a plurality of arms, and the diameter of the plurality of arms, according to one embodiment.

FIG. 15A-15B is an apparatus view of the soap holding apparatus, according to one embodiment.

FIG. 16 is an apparatus view of the soap holding apparatus, according to one embodiment.

FIG. 17 is an apparatus view of the soap holding apparatus, according to one embodiment.

FIG. 18 is an apparatus view of the soap holding apparatus with a plurality of base options, according to one embodiment.

FIG. 19 is a process flow diagram describing a method of manufacturing the soap holding apparatuses of FIGS. 1-8, according to one embodiment.

Other features of the present embodiments will be apparent from the accompanying drawings and from the detailed description that follows.

### DETAILED DESCRIPTION

Example embodiments, as described below, may be used to provide a method and/or a soap holding apparatus to hold and dry a soap bar of various sizes and/or shapes.

In one embodiment, a soap holding apparatus 100 includes a vertical post 102 extending upward from a base 104. The vertical post 102 includes a free end 118 at an uppermost edge 116. A plurality of suspension arms 110 are affixed laterally on the vertical post 102 to hold a bar of soap. Each of the plurality of the suspension arms 110 is divided into two segments. Each of the plurality of suspension arms 110 includes a first segment 112 that laterally affixes each of the plurality of suspension arms 110 to the vertical post 102. Each of the plurality of suspension arms 110 includes a second segment 114 extending from a distal end 124 of the first segment 112 at an obtuse angle 120. A short lean arm 108 is laterally affixed to the vertical post 102 above the suspension arms 110 to support the bar of soap. A long lean arm 106 is laterally affixed to the vertical post 102 above the short lean arm 108 to support the bar of soap.

The soap holding apparatus 100 may include a drip tray 306 that may be laterally affixed to a slot 304 on the vertical post 102 below the plurality of suspension arms 110. The drip tray 306 may collect water dripping from the bar of soap when the bar of soap is held by the plurality of suspension arms 110. The drip tray 306 may be removably attached to the slot 304 on the vertical post 102 below the suspension arms 110. The drip tray 306 may be attached to the vertical post 102 at a lower end 122 of the vertical post 102. The drip tray 306 may be the base for the soap holding apparatus 100.

The second segment 114 may extend from the distal end 124 of the first segment 112 to create the obtuse angle 120. The obtuse angle 120 may range between 130 degrees and 180 degrees to support the bar of soap and/or to prevent the bar of soap from slippage. The base 104 may include a plurality of legs 126 extending outwardly from the lower end 122 of the vertical post 102 to support the soap holding apparatus 100. The soap holding apparatus 100 may be made from plastic, stainless steel, aluminum, titanium, wood, and/or ceramic material.

In another embodiment, a soap holding apparatus 500 includes a horizontal arm 502 extending outward from a center 512 of a bracket 506. A vertical post 102 extending upward from the distal end 514 of the horizontal arm 502. A plurality of suspension arms 110 are affixed laterally to the vertical post 102 to hold a bar of soap. Each of the plurality of the suspension arms 110 is divided into two segments. Each of the plurality of suspension arms 110 includes a first segment 112 laterally affixed to the vertical post 102. Each of the plurality of suspension arms 110 includes a second segment 114 extending at a distal end 124 of the first segment 112 at an obtuse angle 120. A short lean arm 108 is laterally affixed to the vertical post 102 above the plurality of suspension arms 110 to support the bar of soap. A long lean arm 106 is laterally affixed to the vertical post 102 above the short lean arm 108 to support the bar of soap.

The bracket 506 may be attached to an edge 504 of the horizontal arm 502 to affix the soap holding apparatus 100 to a surface. The bracket 506 may include one or more hole 510 to allow insertion of the screws, bolts, and/or suction cups 508 to allow the soap holding apparatus 100 to be affixed to the surface. The bracket 506 may be affixed to the surface by the screws, the suction cups 508, and/or the bolts.

In yet another embodiment, a soap holding apparatus 100 includes a vertical post 102 mounted on a surface in an upright position. A bracket 602 is attached to the vertical post 102 at a lap joint 604 to affix the soap holding apparatus 100 to the surface. The bracket 602 and the vertical post 102 overlap and interlock to securely connect the bracket 602 to the vertical post 102. A plurality of suspension arms 110 are laterally affixed to the vertical post 102 to hold a bar of soap. Each of the plurality of the suspension arms 110 is divided into two segments. Each of the plurality of suspension arms 110 includes a first segment 112 to laterally affix each of the plurality of suspension arms 110 to the vertical post 102. Each of the plurality of suspension arms 110 includes a second segment 114 extending from a distal end 124 of the first segment 112 at an obtuse angle 120. A short lean arm 108 is laterally affixed to the vertical post 102 above the suspension arms 110 to support the bar of soap. A long lean arm 106 is laterally affixed to the vertical post 102 above the short lean arm 108 to support the bar of soap.

The bracket 602 and the vertical post 102 may be secured at the lap joint 604 by an adhesive, a screw, a nail, a frictional force, a hook-and-loop fastener, an interlocking tab and slot 304 mechanism, and/or a snap-fit connection.

In a further embodiment, a method of manufacturing a soap holding apparatus 100 includes extending a vertical post 102 upward from a base 104, the vertical post 102 including a free end 118 at an uppermost edge 116. The method includes affixing a plurality of suspension arms 110 laterally on the vertical post 102 to hold a bar of soap. Each of the plurality of the suspension arms 110 is divided into two segments. Each of the plurality of suspension arms 110 includes a first segment 112 to laterally affix each of the plurality of suspension arms 110 horizontally to the vertical post 102. Each of the plurality of suspension arms 110 includes a second segment 114 extending from a distal end 124 of the first segment 112 at an obtuse angle 120. A short lean arm 108 is affixed laterally to the vertical post 102 above the suspension arms 110 to support the bar of soap. A long lean arm 106 is affixed laterally to the vertical post 102 above the short lean arm 108 to support the bar of soap.

The method of forming the soap holding apparatus 100 may include attaching a drip tray 306 to the vertical post 102 below a lower end 122 of the vertical post 102. The drip tray 306 may be the base and support the vertical post 102 and all of its appendages.

In one embodiment, a soap holding apparatus 900 may comprise an angled post 902. The angle post may comprise an angled lower end 904, an uppermost edge 116, and a free end 118. The angled post 902 may be affixed to a base drip tray 702. The soap holding apparatus 900 may further comprise a plurality of suspension arms 110 affixed laterally on the angled post 902 to hold a bar of soap. Each of the plurality of suspension arms 110 may be divided into two segments. Each of the plurality of suspension arms 110 may comprise a first segment 112 that laterally affixes each of the plurality of suspension arms 110 to the angled post 902. Each of the plurality of suspension arms 110 may comprise a second segment 114 that may extend from a distal end 124 of the first segment 112 at an obtuse angle 120.

The soap holding apparatus 900 may further comprise a short lean arm 108 that may be laterally affixed to the angled post 902 above the plurality of suspension arms 110 to support the bar of soap. The soap holding apparatus 900 may further comprise a long lean arm 106 that may be laterally affixed to the angled post 902 above the short lean arm 106 to support the bar of soap. The base drip tray 702 may be divided into a plurality of thirds 906, the plurality of thirds 906 may comprise a front third 908, a middle third 910, and a rear third 912. The angled post 902 may be affixed within the rear third 912 of the base drip tray 702. The angled post 902 may be angled backward of the base drip tray 702. The angled post 902 may be angled toward an outermost edge 914 of the rear third 912 of the base drip tray 702.

The soap holding apparatus 1000 may further comprise the auxiliary angled post 1006. The auxiliary angled post 1006 may comprise the second uppermost edge 1014 and the second free end 1016. The auxiliary angled post 1006 may be connected to the angled post 902 via the post connector 1002. The post connector 1002 may comprise the groove 1004, the groove 1004 may be formed on bottom side of the post connector 1002. The groove 1004 may be configured to securely attach to the free end 118 of the angled post 902. The soap holding apparatus 1000 may further comprise the plurality of second suspension arms 110 laterally affixed to the auxiliary angled post 1006. Each of the plurality of second suspension arms 110 may be divided into two segments. Each of the plurality of second suspension arms 1012 may comprise the first segment 112 that may laterally affix each of the plurality of second suspension arms 1012 to the auxiliary angled post 1006. Each of the plurality of second suspension arms 1012 may comprise the second segment 114 extending from the distal end 124 of the first segment 112 at the second obtuse angle 1018.

The soap holding apparatus 1000 may further comprise the second short lean arm 1010 laterally affixed to the auxiliary angled post 1006 above the plurality of second suspension arms 1012. The soap holding apparatus 1000 may further comprise the second long lean arm 1008 laterally affixed to the auxiliary angled post 1006 above the second short lean arm 1010.

In one embodiment, a soap holding apparatus 1025 may comprise the extended angled post 1020 extending from the base drip tray 702. The soap holding apparatus 1025 may further comprise the plurality of suspension arms 110 that may be affixed laterally on the extended angled post 1020 to hold the bar of soap. Each of the plurality of suspension arms 110 may be divided into two segments. Each of the plurality of suspension arms 110 may comprise the first segment 112 that may laterally affix each of the plurality of suspension arms 110 to the extended angled post 1020. Each of the plurality of suspension arms 110 may comprise the second segment extending from the distal end 124 of the first segment 112 at the obtuse angle 120.

The soap holding apparatus 1025 may further comprise the short lean arm 108 laterally affixed to the extended angled post 1020 above the plurality of suspension arms 110 to support the bar of soap. The soap holding apparatus 1025 may further comprise the long lean arm 106 laterally affixed to the extended angled post 1020 above the short lean arm 108 to support the bar of soap. The soap holding apparatus 1025 may further comprise the plurality of second suspension arms 1012 laterally affixed to the extended angled post 1020. Each of the plurality of second suspension arms 1012 may be divided into two segments. Each of the plurality of second suspension arms 1012 may comprise the first segment 112 that may laterally affix each of the plurality of suspension arms 1012 to the extended angled post 1020. Each of the plurality of suspension arms 1012 may comprise the second segment 114 extending from the distal end 124 of the first segment 114 at the second obtuse angle 1018.

The soap holding apparatus 1025 may further comprise the second short lean arm 1010 that may be laterally affixed to the extended angled post 1020 above the plurality of second suspension arms 1012. The soap holding apparatus 1025 may further comprise the second long lean arm 1008 laterally affixed to the extended angled post 1020 above the second short lean arm 1010. The base drip tray 702 may be divided into the plurality of thirds 906, the plurality of thirds 906 comprises a front third 908, the middle third 910, and the rear third 912. The extended angled post 1020 may be affixed within the rear third 912 of the base drip tray 702. The extended angled post 1020 may be angled backward of the base drip tray 702. The extended angled post 1020 may be angled toward the outermost edge 914 of the rear third 912 of the base drip tray 702. the base 104 may comprise the plurality of legs 126 extending outwardly from the angled lower end 904 of the extended angled post 1020 to support the soap holding apparatus 1025.

In one embodiment, a soap holding apparatus 1100 may comprise the vertical post 102. The vertical post 102 may comprise the uppermost edge 116, the free end 118, the lower end 122, the plurality of holes 1102, and the threaded hole 1110. The soap holding apparatus 1100 may further comprise the base 104 removably attached to the lower end 122 of the vertical post 102. The soap holding apparatus 1100 may further comprise the plurality of suspension arms 110 removably attached to the vertical post 102 to hold the bar of soap. The soap holding apparatus 1100 may further comprise the short lean arm 108 removably attached to the vertical post 102 above the plurality of suspension arms 110 to support the bar of soap. The soap holding apparatus 1100 may further comprise the long lean arm 106 removably attached to the vertical post 102 above the short lean arm 108 to support the bar of soap.

The plurality of suspension arms 110, the long lean arm 106, and the short lean arm 108 may be removably attached to a plurality of insert holes 1102. The plurality of holes 1102 may comprise a top insert hole 1104, a middle insert hole 1106, and a plurality of bottom insert holes 1108 to affix the long lean arm 106, the short lean arm 108, and the plurality of suspension arms 110 respectively. The short lean arm 108 may be removably attached to the top insert hole 1104 using at least one of friction and snap mechanism. The long lean arm 106 may be removably attached to the middle insert hole 1106 using at least one of friction and snap mechanism. The plurality of suspension arms 110 may be removably attached to the plurality of bottom insert holes 1108 using at least one of friction and snap mechanism. The base 104 may comprise a base drip tray 702 to collect water dripping from the bar of soap. The bar of soap may be held by the plurality of suspension arms 110. The base 104 may comprise a plurality of legs 126 extending outwardly to support the soap holding apparatus. The base 104 may be removably attached to the vertical post 102 by at least one of a screw 1112, peg-and-docket, hook-and-loop, and magnetic connection.

In yet another embodiment, a soap holding apparatus 1300 may comprise a vertical post 102 extending from a base 104. The vertical post 102 may comprise a free end 118 at an uppermost edge 116, and a lower end 122. The soap holding apparatus 1300 may further comprise a hinge 1302 connecting the vertical post 102 to the base 104. The soap holding apparatus 1300 may further comprise a plurality of suspension arms 110 removably attached to the vertical post 102 to hold a bar of soap. The soap holding apparatus 1300 may further comprise a short lean arm 108 removably attached to the vertical post 102 above the plurality of suspension arms 110 to support the bar of soap. The soap holding apparatus 1300 may further comprise a long lean arm 106 affixed detachably to the vertical post 102 above the short lean arm 108 to support the bar of soap. The hinge 1302 may allow the vertical post 102 to pivot between upright and folded positions. The hinge 1302 may be configured to lock the vertical post 102 in upright position.

The vertical post 102 may comprise a plurality of insert holes 1102 for attachment of the plurality of suspension arms 110, the short lean arm 108, and the long lean arm 106. The base 104 may comprise a base drip 702 tray to collect water dripping from the bar of soap. The bar of soap may be held by the plurality of suspension arms 110. The base 104 may comprise a plurality of legs 126 extending outwardly to support the soap holding apparatus 1300.

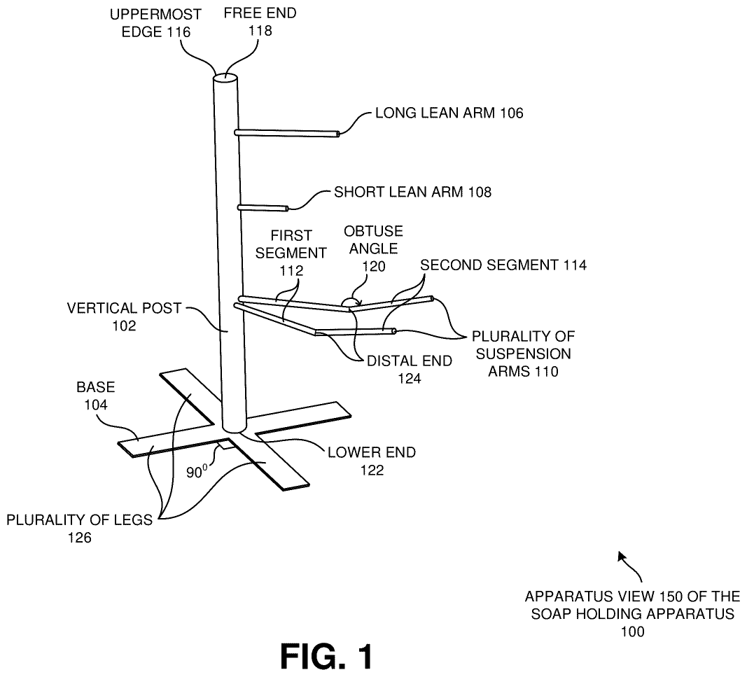

FIG. 1 is an apparatus view of a soap holding apparatus 100 illustrating the components forming the apparatus, according to one or more embodiments. As shown in FIG. 1, the soap holding apparatus 100 comprises a vertical post 102, a base 104, a long lean arm 106, a short lean arm 108, suspension arms 110, a first segment 112, a second segment 114, an uppermost edge 116, a free end 118, an obtuse angle 120, a lower end 122, a distal end 124, and a plurality of legs 126 according to one embodiment.

The soap holding apparatus 100 may comprise an arrangement of various components that may be designed to hold a soap bar while allowing air circulation for drying, according to one embodiment. The vertical post 102 may be a central upright structural component that may provide the support structure for the soap holding apparatus 100. The vertical post 102 may be made of materials including but not limited to, stainless steel, aluminum, plastic, and/or composite materials. The vertical post 102 may be connected to the base 104.

The vertical post 102 may be extended vertically from the base 104 and may comprise the uppermost edge 116 and the free end 118. The vertical post 102 may extend upwards at 90 degrees from the base 104 and/or at any other varying angles to adjust for balanced weight distribution, balancing of soap bar, and/or optimal drying of soap bar. The vertical post 102 may attach with and/or be integral with the long lean arm 106, short lean arm 108, and/or suspension arms 110, each of which may be affixed at various positions along the vertical post 102 to hold the various soap bars, according to one embodiment. The vertical post 102 may be attached to the base 104 by various means including but not limited to, screws, bolts, adhesive bonding, snap-fit attachment, interlocking grooves, and/or welded joints. The vertical post 102 and the base 104 may be made into a single molded piece and/or may eliminate the need for any additional attachment means.

The central positioning of vertical post 102 may allow the vertical post 102 to uniformly distribute the weight and/or force applied by the soap bar. The base 104 may be the foundation of the soap holding apparatus 100. The base 104 may provide stability and/or support for the soap holding apparatus 100. The base 104 may be of various designs and/or shapes including but not limited to a plurality of legs 126, star-shape, square, rectangle, and/or flat and/or oval-shaped to function as both the base 104 and/or a drip tray 306. The base 104 may prevent the soap holding apparatus 100 from tipping over. The base 104 may be made from various materials including but not limited to plastic, stainless steel, aluminum, bamboo, wood, ceramic, and/or composite materials.

The long lean arm 106 may be a support arm that may be affixed to the vertical post 102. and The long lean arm 106 may comprise an end that extends substantially horizontally outward to support the upper part of a bar of soap when the soap is resting on the suspension arms 110, according to one embodiment. The long lean arm 106 may be connected to the vertical post 102 at a variable height below the uppermost edge 116 and/or above the short lean arm 108. The long lean arm 106 may comprise a length between 0.5 inches and 1.25 inches to accommodate. The long lean arm 106 may be attached to the vertical post 102 using various means including but not limited to a socket joint, adhesive bonding, a snap-fit attachment, and/or molded as a single piece with the vertical post 102, according to one embodiment. The long lean arm 106 may be made from various materials including but not limited to plastic, stainless steel, aluminum, bamboo, wood, ceramic, and/or composite materials.

The short lean arm 108 may be a support arm that may be laterally affixed to the vertical post 102. The short lean arm 108 may be connected to the vertical post 102 at a variable height below the long lean arm 106 and/or above the suspension arms 110. The short lean arm 108 may comprise a length between 0.25 inches and 1.00 inches to accommodate and/or support a bar of soap. The short lean arm 108 may be attached to the vertical post 102 using various means including but not limited to a socket joint, adhesive bonding, a snap-fit attachment, and/or molded as a single piece with the vertical post 102. The short lean arm 108 may be shorter in length than the long lean arm 106. The short lean arm 108 may be made from various materials including but not limited to plastic, stainless steel, aluminum, bamboo, wood, ceramic, and/or composite materials.

The suspension arms 110 may comprise a pair of elongated members which may be connected to the vertical post 102. The suspension arms 110 may include a first segment 112, a second segment 114, an obtuse angle 120, and a distal end 122. The suspension arms 110 may attach to the vertical post 102 at a variable height below the short lean arm 108 and/or above the base 104.

The suspension arms 110 may have a length between 1.75 inches and 2.75 inches to accommodate various soap shapes and/or sizes, including but not limited to large bar soap, medium bar soap, and/or small bar soap. The suspension arms 110 may be constructed from various materials, including but not limited to plastic, stainless steel, aluminum, bamboo, wood, ceramic, and/or composite materials. The suspension arms 110 may comprise a roughed and/or tacky surface to further prevent a bar of soap from slipping off of the suspension arms 110.

The suspension arms 110 may be attached to the vertical post 102 substantially adjacent to one another, forming an acute angle between them. This acute angle, or the space between the suspension arms 110, may align with the long lean arm 106 and/or the short lean arm 108, which may ensure that all these components are positioned within the same plane. The long lean arm 106 may extend laterally from the vertical post 102 above the short lean arm 108, while the short lean arm 108 may extend above the suspension arms 110. The spatial configuration of the suspension arms 110 may provide stable support for various soap bars, where the alignment between the long lean arm 106, short lean arm 108, and the angle or space between the suspension arms 110 may ensure that the soap remains secure while being easily accessible.

Each suspension arm 110 may include a first segment 112 and/or a second segment 114. The first segment 112 may be a horizontal segment that may extend from the vertical post 102. The first segment 112 may provide a stable horizontal base to cradle the soap bar. The first segment 112 may comprise a length between 1.00 inches and 1.75 inches. The first segment 112 may be attached to the vertical post 102 using various means including but not limited to, a socket joint, molded as a single piece with the vertical post 102 and second segment 114, a screw, a bolt, and/or an adhesive bonding, according to one embodiment.

The second segment 114 may extend from the distal end 124 of the first segment 112. The angle, surface contact, and/or upward bent of the second segment 114 may keep the soap bar in place. The upward orientation of the second segment 114 from the first segment 112 may assist the soap bar to remain positioned and/or rest on the suspension arms 110. The second segment 114 may be angled upwards at the obtuse angle 120 ranging between 130 degrees and 180 degrees to create a barrier that may prevent the soap bar from falling and/or slipping off of the suspension arms 110.

The first segment 112 and second segment 114 may be connected at the obtuse angle 120 and/or the distal end 124 using various means including but not limited to a hinge attachment, an adhesive bonding, a welded joint, and/or molded as a single piece. The connection may ensure both the first segment 112 and the second segment 114 maintain structural integrity to support the soap bar in place, according to one embodiment.

The uppermost edge 116 may be the top edge and/or boundary of the vertical post 102. The height of the uppermost edge 116 may provide variable space for the long lean arm 106 to accommodate various attachments including but not limited to adjustable brackets, hooks, and/or additional support arms.

The free end 118 may be a terminal and/or end of the vertical post 102 which may be unattached to any other structure. The free end 118 may allow unobstructed air circulation around the bar of soap.

The obtuse angle 120 may be the angle formed between the first segment 112 and the second segment 114 of the suspension arms 110. The obtuse angle 120 may range between 130 degrees and 180 degrees to hold a soap bar in place, which may prevent the soap bar from slipping off, and/or allow drainage of excess water. The lower end 122 may be the bottom portion of the vertical post 102 where the vertical post 102 may be connected to the base 104. The lower end 122 may be connected to the base 104 via one or more of a snap-fit mechanism, socket joint, adhesive bonding, threaded connection, welded joint, and/or molded as a single piece.

The distal end 124 may be the terminal end of the first segment 112 of the suspension arms 110. The distal end 124 may form the part of the structure that may form the obtuse angle 120. The connection between the first segment 112 and the second segment 114 at the distal end 124 may be attached via one or more of a socket joint, adhesive bonding, threaded connection, welded joint, and/or molded as a single piece.

The plurality of legs 126 may be one or more legs extending outward from the lower end 122 of the vertical post 102. The plurality of legs 126 of the base 104 may provide support and/or stability to the soap holding apparatus 100. The plurality of legs 126 may distribute the weight of the soap holding apparatus 100 uniformly. The plurality of legs 126 may be connected to the lower end 122 of the vertical post 102 via one or more of an adhesive bonding, threaded connection, welded joint, and/or molded as a single piece. The plurality of legs 126 may be made of various materials including but not limited to plastic, stainless steel, aluminum, bamboo, wood, ceramic, and/or composite materials.

According to one or more embodiments, FIG. 1 shows a soap holding apparatus 100 that may comprise a vertical post 102 that may extend upward from a base 104. The vertical post 102 may be attached to the base via one or more of a snap-fit mechanism, socket joint, adhesive bonding, threaded connection, welded joint, and/or molded as a single piece. The base 104 may comprise a plurality of legs 126 extending outwardly from a lower end 122 of the vertical post 102 to support the soap holding apparatus 100 when in a standing position. The vertical post 102 may attach to the base 104 at a center of the base 104 and/or where the plurality of legs 126 cross. The vertical post 102 and the base 104 may be substantially perpendicular to one another.

The vertical post 102 may comprise a free end 118 at an uppermost edge 116. The soap holding apparatus 100 may further comprise a plurality of suspension arms 110 affixed laterally on the vertical post 102 to hold a bar of soap. The plurality of suspension arms 110 may be attached to the vertical post 102 via one or more of a snap-fit mechanism, socket joint, adhesive bonding, threaded connection, welded joint, and/or molded as a single piece. The plurality of suspension arms 110 may be attached to the vertical post 102 above the lower end 122 and below at least one of the long lean arm 106 and the short lean arm 108, according to one embodiment.

Each of the plurality of the suspension arms 110 may be divided into two segments. Each of the plurality of suspension arms 110 may comprise a first segment 112 that laterally affixes each of the plurality of suspension arms 110 to the vertical post 102. Each of the plurality of suspension arms 110 may further comprise a second segment 114 that may extend from the distal end 122 of the first segment 112 at an obtuse angle 120.

The second segment 114 that may extend from the distal end 122 of the first segment 112 may create the obtuse angle 120. The obtuse angle 120 may range between 130 degrees and 180 degrees and may support the bar of soap and/or prevent the bar of soap from slippage. The soap holding apparatus 100 may further comprise a short lean arm 108 that may be laterally affixed to the vertical post 102 above the suspension arms 110 to support the bar of soap. The soap holding apparatus 100 may further comprise a long lean arm 106 laterally affixed to the vertical post 102 above the short lean arm 108 to support the bar of soap. The soap holding apparatus 100 and its various components may be made from including but not limited to, at least one of plastic, stainless steel, aluminum, titanium, wood, and/or ceramic material.

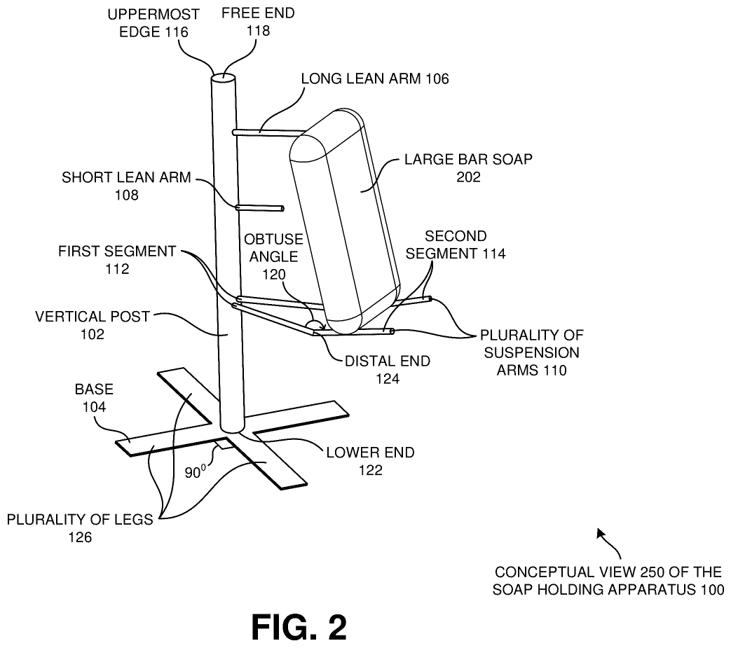

FIG. 2 is a conceptual view 250 of the soap holding apparatus 100 of FIG. 1, according to one embodiment. FIG. 2 illustrates the vertical post 102, the base 104, the long lean arm 106, the short lean arm 108, the suspension arms 110, the first segment 112, the second segment 114, the uppermost edge 116, the free end 118, the obtuse angle 120, the lower end 122, the distal end 124, the plurality of legs 126, and a large bar soap 202.

The large bar soap 202 may be a large block of the cleansing agent that may be composed of a mixture of natural and/or synthetic fats and/or alkalis. The large bar soap 202 may be used for personal hygiene, cleaning purposes, and/or various applications including but not limited to removing dirt, grease, and/or microbes. The large bar soap 202 may be supported by the first segment 112, the second segment 114, and/or the obtuse angle 120 of the suspension arms 110. The large bar soap 202 may lean against the long lean arm 106.

The long lean arm 106 may provide support to the large bar soap 202. By positioning the large bar soap 202 against the long lean arm 106 the soap bar may be kept stable and/or elevated for efficient drying. The long lean arm 106 may prevent the large bar soap 202 from tipping over and/or falling off the soap holding apparatus 100. The elevated position of the large soap bar 202 may ensure the large bar soap 202 does not sit in residual water which may prevent the large bar soap 202 from becoming soggy and/or dissolving prematurely.

The first segment 112 of the suspension arms 110 may hold the lower part of the large bar soap 202. The first segment 112 of the suspension arms 110 may allow any excess water to drain off from the large bar soap 202. The second segment 114 may be connected to the first segment 112 of the suspension arms 110. The second segment 114 may prevent the large bar soap 202 from slipping off the soap holding apparatus 100. The obtuse angle 120 between 130 degrees and 180 degrees from the distal end 122 of the first segment 112 may function as a barrier that may prevent the large bar soap 202 from dislodging in conditions including but not limited to wetness and/or slipperiness.

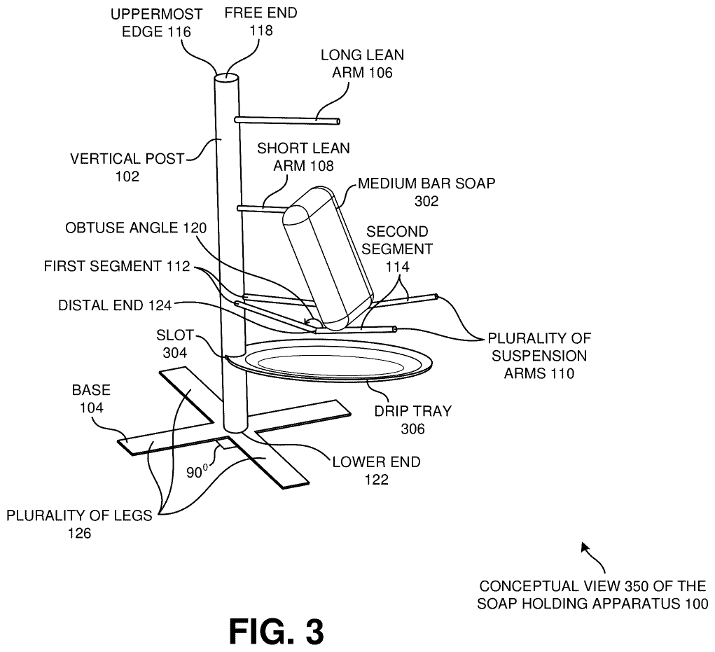

FIG. 3 is a conceptual view 350 of the soap holding apparatus 100 of FIG. 1, according to one embodiment. FIG. 3 illustrates the vertical post 102, the base 104, the long lean arm 106, the short lean arm 108, the suspension arms 110, the first segment 112, the second segment 114, the uppermost edge 116, the free end 118, the obtuse angle 120, the lower end 122, the distal end 124, the plurality of legs 126, a medium bar soap 302, a slot 304, and/or a drip tray 306.

The medium bar soap 302 may be a medium block of the cleansing agent that may be composed of a mixture of natural and/or synthetic fats and/or alkalis. The medium bar soap 302 may be used for personal hygiene, cleaning purposes, and/or various applications including but not limited to removing dirt, grease, and/or microbes. The medium bar soap 302 may be derived from the large bar soap 202 through reduction in size. The medium bar soap 302 may be supported by the first segment 112, the second segment 114, and/or the obtuse angle 120 of the suspension arms 110. The medium bar soap 302 may lean against the short lean arm 108. The medium bar soap 302 may lean against the short lean arm 108 which may allow drying and/or prevent water accumulation. The short lean arm 108 may prevent the medium bar soap 302 from tipping over and/or falling off the soap holding apparatus 100.

The first segment 112, the second segment 114, and/or the obtuse angle 120 of the suspension arms 110 may support the medium bar soap 302. The first segment 112 of the suspension arms 110 may allow any excess water to drain off from the medium bar soap 302. The obtuse angle 120 between 130 degrees and 180 degrees from the distal end 122 of the first segment 112 may function as a barrier that may prevent the medium bar soap 302 from dislodging in conditions including but not limited to wetness and/or slipperiness. The soap holding apparatus 100 may comprise the slot 304. The slot 304 may be a narrow opening and/or groove where the drip tray 306 may be held and/or attached in place. The slot 304 may be located on the vertical post 102 below the suspension arms 110.

The soap holding apparatus 100 may further comprise a drip tray 306 that may be laterally affixed to a slot 304 on the vertical post 102 below the plurality of suspension arms 110. The drip tray 306 may be a container, a dish, and/or a flat surface. The drip tray 306 may be removably attached to the slot 304 on the vertical post 102 below the suspension arms 110. The drip tray 306 may be of any shape. The drip tray 306 may collect water dripping from the bar of soap when the bar of soap is held by the plurality of suspension arms 110. The drip tray 306 may be slightly concave and/or may include raised edges to prevent water from spilling over onto the surface The drip tray 306 may be attached to the vertical post 102 via the slot 304 above the lower end 122 of the vertical post 102. The drip tray 306 may be the base for the soap holding apparatus 100. The drip tray 306 may be attached and/or detached to the vertical post 102 by various means including but not limited to a slide-in attachment, snap-on attachment, magnetic attachment, bracket or hook attachment, and/or twist-lock attachment.

The drip tray 306 may be used to catch any water spills and/or soap bar residue that may drip from a soap bar while the soap bar is drying on the soap holding apparatus 100. The drip tray 306 may keep the area around the soap bar clean and dry and may prevent the water from accumulating on surfaces and/or causing mess and/or damage, according to one embodiment. The drip tray 306 may measure between 1.75 inches and 2.75 inches long and/or 1.75 inches and 2.50 inches wide. The drip tray 306 may be removed for cleaning to maintain hygiene.

According to one or more embodiments, FIG. 3, shows the soap holding apparatus 100 that may further comprise a drip tray 306 that may be laterally affixed to a slot 304 on the vertical post 102 below the plurality of suspension arms 110. The drip tray 306 may collect water dripping from the bar of soap when the bar of soap is held by the plurality of suspension arms 110. The drip tray 306 may be removably attached to the slot 304 on the vertical post 102 below the suspension arms 110.

The drip tray 306 may be attached to the vertical post 102 below a lower end 122 of the vertical post 102. The drip tray 306 may be the base for the soap holding apparatus 100. The drip tray 306 may collect water dripping from the bar of soap when the bar of soap is held by the plurality of suspension arms 110.

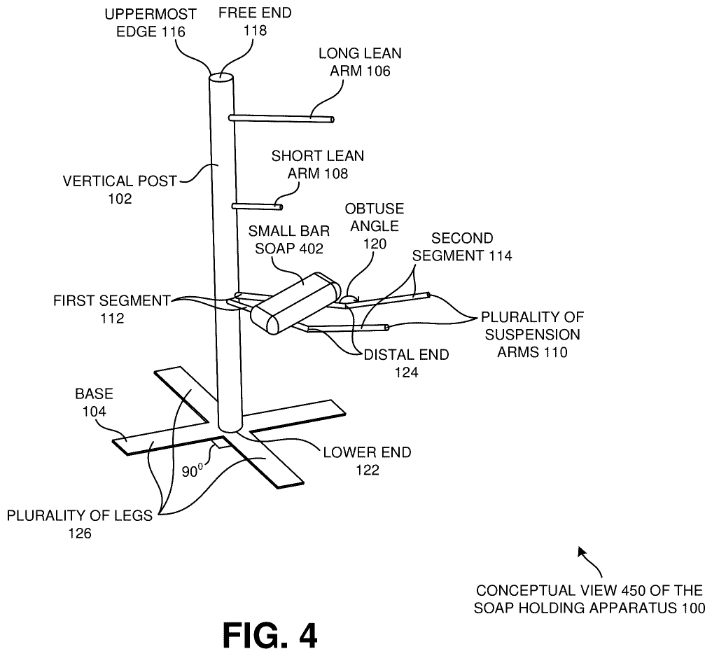

FIG. 4 is a conceptual view 450 of the soap holding apparatus 100 of FIG. 1 illustrating a small bar soap 402 placed on the first segment 112 of the suspension arms 110, according to one or more embodiments. FIG. 4 illustrates the vertical post 102, the base 104, the long lean arm 106, the short lean arm 108, the suspension arms 110, the first segment 112, the second segment 114, the uppermost edge 116, the free end 118, the obtuse angle 120, the lower end 122, the distal end 124, the plurality of legs 126, and a small bar soap 402.

The small bar soap 402 may be a compact solid cleansing agent that may be smaller in size and/or weight. The small bar soap 402 may be utilized for including but not limited to, personal hygiene, cleansing application, and/or travel purposes. The small bar soap 402 may exhibit diminished size due to prior use. The small bar soap 402 may be placed on the first segment 112 of the suspension arms 110 in a resting state.

The first segment 112, the second segment 114, and/or the obtuse angle 120 of the suspension arms 110 may hold the small soap bar 402 in a resting state. The first segment 112, the second segment 114, and/or the obtuse angle 120 of the suspension arms 110 may support and/or may provide stable minimal surface contact to enhance the drying of the small soap bar 402. The minimal surface area may reduce the contact points of the small soap bar 402 to the suspension arms 110. The minimal surface contact may allow air to circulate freely around the small bar soap 402 which may provide effective drying. The reduced contact points may prevent the small bar soap 402 from including but not limited to, becoming soggy, reduce the contamination risks, and/or limit the area where residue and/or moisture may accumulate.

The second segment 114 may provide physical support that may secure the small bar soap 402 in place above a surface to encourage optimal drying. The second segment 114 may prevent the small bar 402 of soap from slipping off the soap holding apparatus 100. The obtuse angle between 130 degrees and 180 degrees from the distal end 122 of the first segment 112 may function as a barrier that may prevent the small bar soap 402 from dislodging in conditions including but not limited to wetness and/or slipperiness. The second segment 114 may restrain and/or maintain the small bar soap 402 position on the first segment 112.

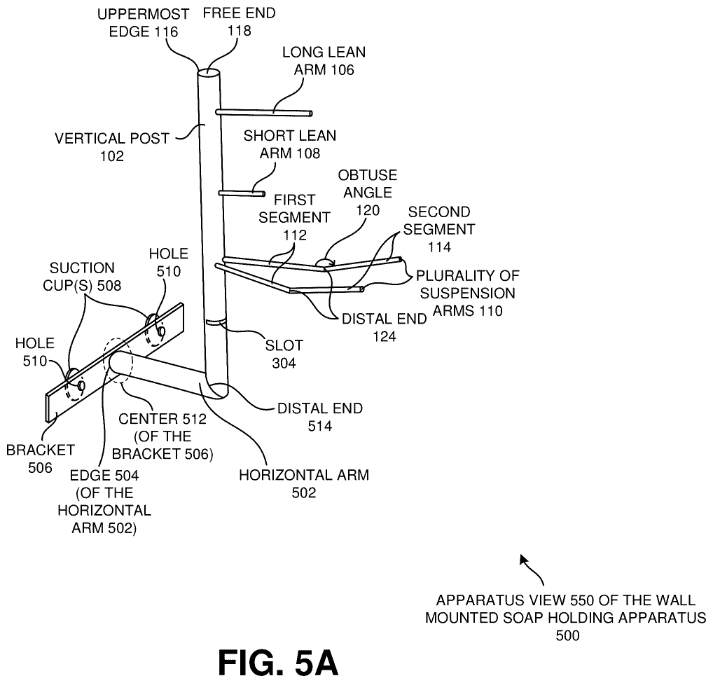

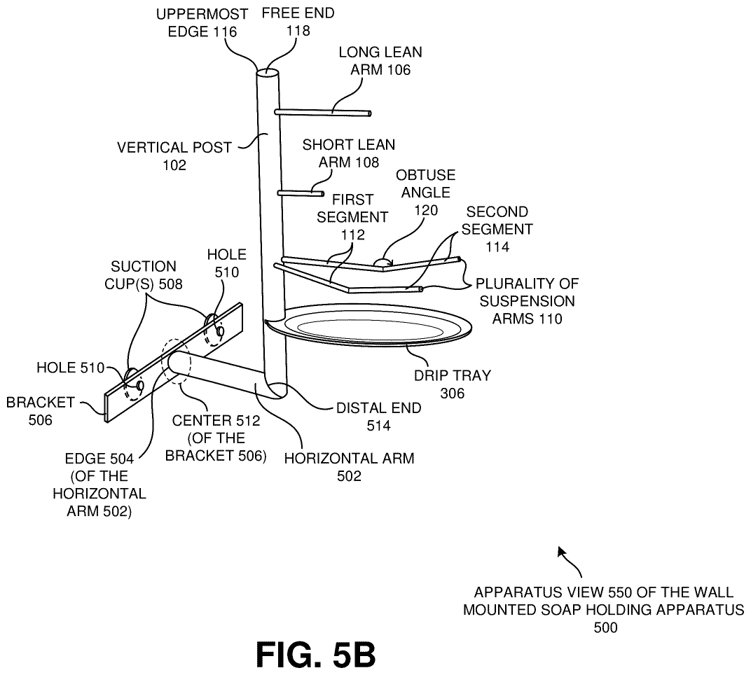

FIG. 5 are an apparatus view 550 of a wall-mounted soap holding apparatus 500, according to one embodiment. FIGS. 5A-5B illustrate the vertical post 102, the long lean arm 106, the short lean arm 108, the suspension arms 110, the first segment 112, the second segment 114, the uppermost edge 116, the free end 118, the obtuse angle 120, the distal end 124, the slot 304, the drip tray 306, a horizontal arm 502, an edge 504 (of the horizontal arm 502), a bracket 506, a suction cup(s) 508, a hole 510, a center 512 (of the bracket 506), and a distal end 514, according to one embodiment.

The wall-mounted soap holding apparatus 500 may comprise an arrangement of various components that may be designed to keep a soap bar elevated and away from surfaces that may collect water and/or dirt to reduce the chance of bacterial growth, according to one embodiment. The wall-mounted soap holding apparatus 500 may be designed with minimal contact points on the soap bar to prevent the soap bar from sticking, have less surface area for dirt, prevent bacteria accumulation, and/or reduce soap residue build-up. The wall-mounted soap holding apparatus 500 may allow for increased air circulation around the soap bar and may help the soap bar dry faster and stay firm and/or undegraded. The wall-mounted soap apparatus 500 may be affixed on a surface by various means including but not limited to the suction cup(s) 508, screws, magnets, double-sided tape, and/or glue. The wall-mounted soap holding apparatus 500 may be constructed from materials including but not limited to, wood, plastic, ceramics, aluminum, titanium, and/or stainless steel and may ensure long-lasting performance even in moist and/or humid environments including but not limited to bathrooms and/or kitchens.

According to one or more embodiments, FIG. 5(A) shows the wall-mounted soap holding apparatus 500 comprising the slot 304 with the option of attaching a drip tray 306 into the slot 304. In FIG. 5(A), the wall-mounted soap holding apparatus 500 comprises the horizontal arm 502, according to one or more embodiment. The horizontal arm 502 may be attached to a center 512 of the bracket 506 to affix the wall-mounted soap holding apparatus 500 to the surface. The surface may be wall surface and/or countertop surface where the apparatus may be mounted and/or placed. The surface may include various surfaces including but not limited to, bathroom tiles, kitchen tiles, painted walls, mirrors, and/or shower walls. The horizontal arm 502 may be affixed to the center 512 of the bracket 506 using various means including but not limited to, one or more screws, snap-fit attachment, detent, and groove attachment, rotational locking attachment, magnetic attachment, threaded connection, and/or welded joints. The horizontal arm 502 may allow the wall-mounted soap holding apparatus 500 to extend outward from the surface which may create a convenient and/or accessible spot for placing one or more soap bars.

The vertical post 102 may extend upward between 70 degrees and 120 degrees angles from the distal end 514 of the horizontal arm 502. The vertical post 102 may be attached to the distal end 514 of the horizontal arm 502 using various means including but not limited to, threaded connection, snap-fit attachment, adhesive bonding, bracket or clamp, single mold, and/or welding.

The vertical post 102 may comprise the slot 304 located below the suspension arms 110, according to one embodiment. The slot 304 of the vertical post 102 of the wall-mounted soap holding apparatus 500 may be a narrow opening and/or groove where the drip tray 306 may be connected and/or detached. The absence of the drip 306 tray may allow any water and/or soap residue on the soap bar to drip directly downward.

The wall-mounted soap holding apparatus 500 may comprise the bracket 506. The bracket 506 may be attached to the horizontal post 502 using various fastening means including but not limited to screws and bolts, welded joint, adhesive bonding, single mold, interlocking, and/or clamp or collar to ensure stability and/or durability. The bracket 506 may comprise a length between 1.00 inches and 2.00 inches long. The bracket 506 may be affixed to the surface by at least one of screws, the suction cup(s) 508, bolts, one or more magnets, double-sided tape, and/or glue.

The bracket 506 may comprise the suction cup(s) 508. The suction cup(s) 508 may be a fixture that may use the force of suction to stick and/or adhere to smooth and/or solid surfaces. The suction cup(s) 508 may work by pressing the suction cup(s) 508 against the surface, pushing out the air, and may create a partial vacuum. This vacuum may hold the suction cup(s) 508 in place due to the pressure pushing against the suction cup(s) 508 from the outside. The suction cup(s) 508 may be attached to the rear side of the bracket 506 by fitting into one or more pre-drilled holes 510 and/or slots designed to hold the suction cup(s) 508 firmly in place.

The suction cup(s) 508 may include a stem and/or a knob that may fit snugly into the holes to ensure the suction cup(s) 508 stays in place. The suction cup(s) 508 may be glued and/or snapped into position with the one or more holes 510, which may depend on the design of the bracket 506. The suction cup(s) 508 may be made from materials including but not limited to rubber and/or plastic. The hole 510 may be a circular opening located on the bracket 506 which may be used to mount and/or secure the wall-mounted soap holding apparatus 500. The hole 510 may serve various functions including but not limited to accommodating fasteners, screws, bolts, and/or suction cup(s) 508 which may attach the bracket to the wall and/or other surfaces. The hole 510 may allow for alignment and/or positioning adjustment during the installation of the wall-mounted soap holding apparatus 500.

According to one or more embodiments, FIG. 5B shows the wall-mounted soap holding apparatus 500 with the drip tray 306 laterally affixed to the slot 304. The drip tray 306 may be attached to the slot 304 on the vertical post 102 below the suspension arms 110. The drip tray 306 may be a container, a dish, and/or a flat surface. The drip tray 306 may be detachable. The drip tray 306 may be attached and/or detached to the vertical post 102 by various means including but not limited to a slide-in attachment, snap-on attachment, magnetic attachment, bracket or hook attachment, and/or twist-lock attachment.

The drip tray 306 may be used to catch any water spills and/or soap bar residue that may drip from a soap bar while the soap bar is drying and resting on the suspension arms 110 of the wall-mounted soap holding apparatus 500. The drip tray 306 may keep the area around the soap bar clean and dry and may prevent the water from accumulating on surfaces and/or causing mess and/or damage, according to one embodiment. The drip tray 306 may measure between 1.75 inches and 2.75 inches long and/or 1.75 inches and 2.50 inches wide. The drip tray 306 may be removed for cleaning to maintain hygiene.

According to one or more embodiments, FIG. 5B shows the soap holding apparatus 500 which may comprise a horizontal arm 502 extending outward from a center 512 of a bracket 506. The bracket 506 may be attached to an edge 504 of the horizontal arm 502 to affix the soap holding apparatus 500 to a surface, according to one embodiment. The bracket 506 may comprise one or more holes 510 to allow insertion of at least one of the screws (not shown), bolts (not shown), and/or one or more suction cup(s) 508 to allow the soap holding apparatus 500 to be affixed to a surface. The bracket 506 may be affixed to the surface by at least one of the screws, the suction cup(s) 508, and the bolts.

The soap holding apparatus 500 of FIG. 5B may further comprise a vertical post 102 that may extend upward from the distal end 124 of the horizontal arm 502. The soap holding apparatus 500 may further comprise a plurality of suspension arms 110 affixed laterally to the vertical post 102 to hold a bar of soap. Each of the plurality of the suspension arms 110 may be divided into two segments. Each of the plurality of suspension arms 110 may comprise a first segment 112 laterally affixed to the vertical post 102. Each of the plurality of suspension arms 110 may comprise a second segment 114 that may extend from the distal end 124 of the first segment 112 at the obtuse angle 120. The second segment 114, which may extend from the distal end 124 of the first segment 112, creates the obtuse angle 120. The obtuse angle 120 may range between 130-degrees and 180-degrees and may support the bar of soap and/or prevent the bar of soap from slippage. The soap holding apparatus 500 may further comprise a short lean arm 108 that may be laterally affixed to the vertical post 102 above the plurality of suspension arms 110 to support the bar of soap, according to one embodiment. The soap holding apparatus 500 may further comprise a long lean arm 106 that may be laterally affixed to the vertical post 102 above the short lean arm 108 to support the bar of soap, according to one embodiment.

The soap holding apparatus 500 may further comprise a drip tray 306 that may be laterally affixed to a slot 304 on the vertical post 102 below the plurality of suspension arms 110. The drip tray 306 may be removably attached to the slot 304 on the vertical post 102 below the suspension arms 110. The drip tray 306 may collect water dripping from the bar of soap when the bar of soap is held at least partially by the plurality of suspension arms 110.

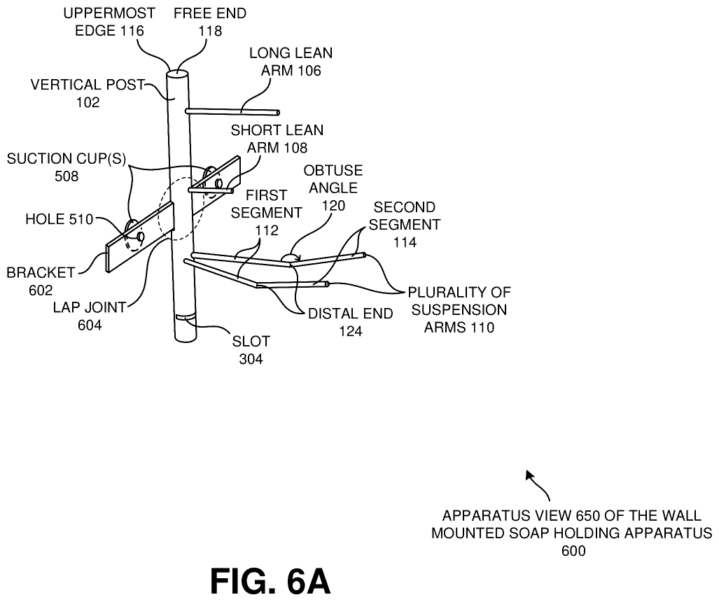

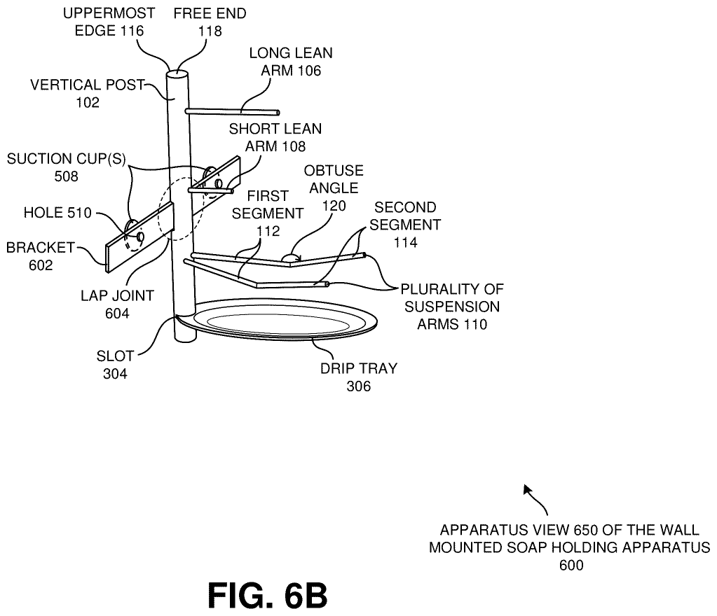

FIGS. 6A-6B are an apparatus view 650 of the wall mounted soap holding apparatus 600, according to one embodiment. FIGS. 6A-6B illustrate the soap holding apparatus 600 comprising the vertical post 102, the long lean arm 106, the short lean arm 108, the suspension arms 110, the first segment 112, the second segment 114, the uppermost edge 116, the free end 118, the obtuse angle 120, the distal end 124, the slot 304, the drip tray 306, the suction cup(s) 508, the hole 510, a bracket 602, and a lap joint 604, according to one or more embodiment.

The wall-mounted soap holding apparatus 600 may comprise the bracket 602. The bracket 602 may be designed to firmly attach to various surfaces including but not limited to, bathroom tiles, kitchen tiles, painted walls, mirrors, and/or shower walls. The bracket 602 may provide a stable foundation for the wall-mounted soap holding apparatus 600 to ensure the wall-mounted soap holding apparatus 600 remains firmly in place. The bracket 602 may be mounted on the wall by various means including but not limited to the suction cup(s) 508, screws, magnets, double-sided tape, and/or glue. The bracket 602 may comprise a length between 1.00 inches and 4.00 inches.

The wall-mounted soap holding apparatus 600 may comprise the lap joint 604. The lap joint 604 may be where the bracket 602 and the vertical post 102 of the wall-mounted soap holding apparatus 600 overlap each other. The lap joint 604 may include cutouts and/or notches on the bracket 602 and the vertical post 102 that fit together tightly which may create a strong connection and may allow the bracket 602 and the vertical post 102 to interlock. The lap joint 604 may be reinforced by various means including but not limited to, screws, glue, wooden pins, metal brackets or straps, welding or brazing, and/or rivets. The materials used in the lap joint 604 may resist corrosion and/or wear, which may ensure the longevity of the connection of the lap joint 604 between the bracket 602 and the vertical post 102 of the wall-mounted soap holding apparatus 600 despite frequent use and/or exposure to water.

According to one or more embodiments, FIG. 6A illustrates the attachment of the components of the wall mounted soap holding apparatus 600, according to one embodiment. The bracket 602 may connect the vertical post 102 to the surface and/or wall via the lap joint 604. The bracket 602 may comprise the suction cup(s) 508 and/or slots 304 that may allow secure attachment to various vertical surfaces including but not limited to the bathroom, shower wall, painted walls, mirrors, and/or kitchen tiles. The vertical post 102 and the bracket 602 may overlap at the lap joint 604 to connect and/or affix the vertical post 102 to the bracket 602. The vertical 102 may be connected to the bracket 602 at the lap joint 604 using various means including but not limited to adhesive bonding, a snap-fit attachment, a welded joint, and/or molded as a single piece. The lap joint 604 may be reinforced using various means including but not limited to screw, glue, and/or the suction cup(s) 508.

According to one or more embodiments, FIG. 6B illustrates the attachment of the drip tray 306 to the slot 304 of the vertical post 102 of the wall mounted soap holding apparatus 600. The drip tray 306 may be positioned below the suspension arms 110 to catch any excess water that may drip from the soap bar. The drip tray 306 may be attached to the slot 304 of the vertical post 102 using various means including but not limited to a snap-fit connection, slide-in attachment, hook and lock attachment, and/or adhesive bonding. The wall-mounted soap holding apparatus 600 may keep the soap bar secure and/or may allow the drip tray 306 to catch any excess water that may drip from the soap bar and/or maintain a clean and/or dry environment.

According to one or more embodiments, FIG. 6B shows a wall mounted soap holding apparatus 600 that may comprise a vertical post 102 that may be mounted on a surface in an upright position. The soap holding apparatus 600 may comprise the drip tray 306 that may be laterally affixed to a slot 304 on the vertical post 102 below the plurality of suspension arms 110. The drip tray 306 may collect water dripping from the bar of soap when the bar of soap is held by the plurality of suspension arms 110. The drip tray 306 may be removably attached to the slot 304 on the vertical post 102 below the suspension arms 110.

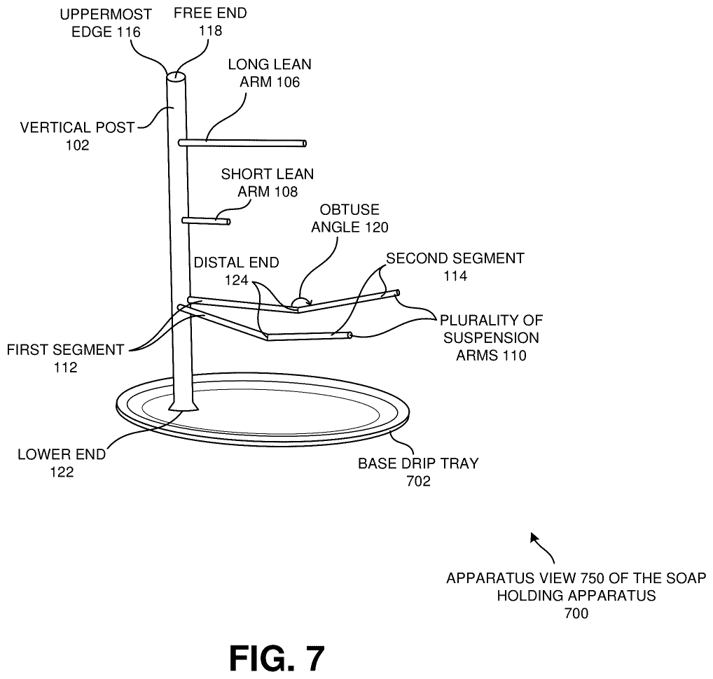

FIG. 7 is an apparatus view 750 of a soap holding apparatus 700, according to one embodiment. FIG. 7 illustrates the vertical post 102, the long lean arm 106, the short lean arm 108, the suspension arms 110, the first segment 112, the second segment 114, the uppermost edge 116, the free end 118, the obtuse angle 120, the lower end 122, the distal end 124, and a base drip tray 702 designed to place the soap holding apparatus 700 on the flat surface and/or on the countertop.

According to one or more embodiments, FIG. 7 shows a soap holding apparatus 700 that may comprise the base drip tray 702. The base drip tray 702 of the soap holding apparatus 700 may be designed to allow the soap holding apparatus 700 to stand securely on a surface. The base drip tray 702 may be connected to the vertical post 102 at a lower end 122 of the vertical post 102. The position of the base drip tray 702 may distribute the weight evenly. The base drip tray 702 may prevent the soap holding apparatus 700 from tipping over and may ensure that the soap holding apparatus 700 remains upright, and/or balanced when placed on a surface. The base drip tray 702 may measure between 2.00 inches and 3.25 inches long and/or 1.75 and 2.75 inches wide.

The base drip tray 702 may collect excess water and/or soap residue which may drip from the soap bar after the soap bar may be placed on the soap holding apparatus 700. The base drip tray 702 may be slightly concave and/or may include raised edges to prevent water from spilling over onto the surface. The base drip tray 702 may be removable and/or detachable from the lower end 122 of the vertical post 102 which may allow for easy cleaning and/or maintenance. Additionally, the base drip tray 702 may be interchangeable with the base 104. The base drip tray 702 may be interchanged with the base 104 using various means including but not limited to a snap-in connection, sliding mechanism, magnetic coupling, and/or adhesive bonding.

The base drip tray 702 may attach to the vertical post 102 by various means. including but not limited to, a snap-in attachment, a groove attachment, adhesive bonding, molded as a single piece with the vertical post 102, a threaded attachment, and/or magnetic coupling. This design may ensure the vertical post 102 remains stable during use which may prevent any accidental displacement of the soap holding apparatus 700.

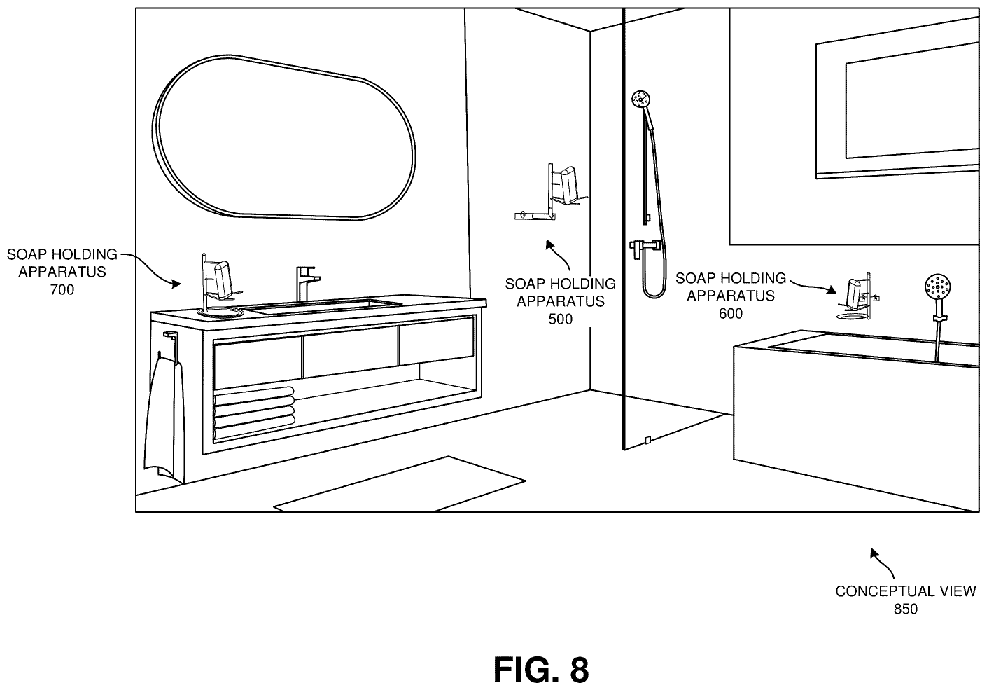

In yet another embodiment, FIG. 8 is a conceptual view 850 of a bathroom environment, according to one embodiment. FIG. 8 illustrates multiple placements of the soap holding apparatus 100, the soap holding apparatus 500, and the soap holding apparatus 600.

The soap holding apparatus 100 may be placed on a flat surface near the sink and/or countertop. The soap holding apparatus 100 may hold soap bars of various sizes including but not limited to a large bar soap 202, medium bar soap 302, and/or small bar soap 402 to dry and/or prevent the soap from becoming soggy and/or slippery.

The soap holding apparatus 500 may be mounted in the shower area on the wall of a bathroom. The wall mount placement of the soap holding apparatus 500 may allow convenient access to the soap bar while taking a shower. The horizontal post 502 may allow the soap holding apparatus 500 to extend outward from the wall. The soap holding apparatus 500 may be mounted on the wall using various means including but not limited to screws and bolts, welded joints, adhesive bonding, interlocking, clamp or collar, and/or suction cups 508.

The soap holding apparatus 600 may be attached to the wall beside the bathtub. The bracket 506 may be attached to the various surfaces including but not limited to bathroom tiles, kitchen tiles, and/or shower walls. The bracket 602 may provide a stable foundation for wall-mounted soap holding apparatus 600. The bracket 602 may be attached to the wall using various means including but not limited to screw, magnet, double-sided tape, glue, adhesive, and/or suction cup. The bracket 602 may comprise the lap joint 604 to affix the soap holding apparatus 600. The lap joint 604 attachment may allow installation and/or uninstallation of the soap holding apparatus 600.

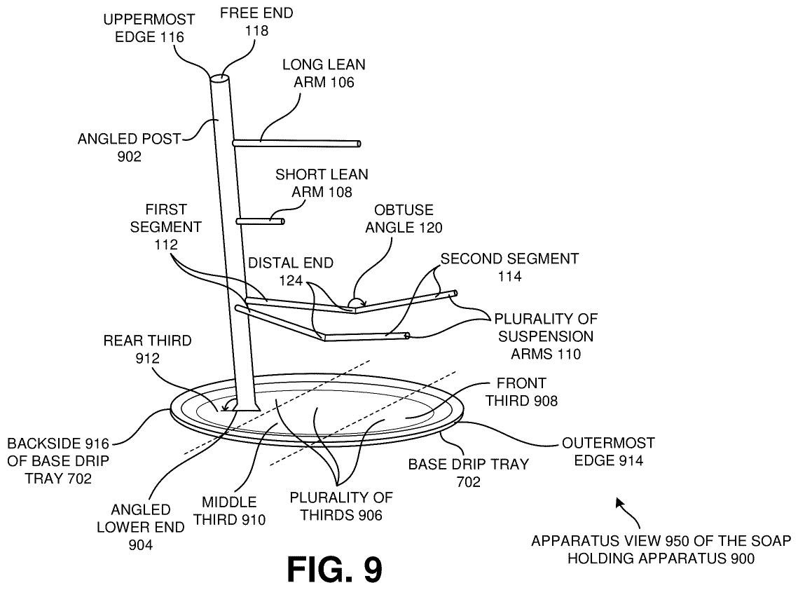

FIG. 9 is an apparatus view 950 of a soap holding apparatus 900 illustrating the components forming the soap holding apparatus 900, according to one or more embodiments. As shown in FIG. 9, the soap holding apparatus 900 comprises a long lean arm 106, a short lean arm 108, a plurality of suspension arms 110, a first segment 112, a second segment 114, an uppermost edge 116, a free end 118, an obtuse angle 120, a distal end 124, a base drip tray 702, an angled post 902, an angled lower end 904, a plurality of thirds 906, a front third 908, a middle third 910, a rear third 912, and an outermost edge 914, according to one embodiment.

The soap holding apparatus 900 may comprise an angled post 902, the angled post 902 may lean backward relative to the base drip tray 702. The angled post 902 may be affixed within the rear third 912 of the base drip tray 702 at the angled lower end 904, and may extend upward to the free end 118. The angled post 902 may comprise the uppermost edge 116 at top portion. The angled configuration of the angled post 902 may be inclined rearward to enhance stability and/or accessibility of a bar of soap, according to one embodiment.

The angled post 902 may be an elongated structural member extending obliquely upward from the base drip tray 702 at an angle between 70 degrees and 120 degrees relative to the horizontal plane of the base drip tray 702. The angled post 902 may comprise the uppermost edge 116, the free end 118, and the angled lower end 904. The angled post 902 may support components, including but not limited to the long lean arm 106, the short lean arm 108, and/or the plurality of suspension arms 110, according to one embodiment.

The angled lower end 904 may be the bottom portion of the angled post 902 affixed within the rear third 912 of the base drip tray 702. The angled lower end 904 may be configured to be mounted on the base drip tray 702. The angled lower end 904 may be secured by various means including but not limited to adhesive bonding, molded fitting, friction lock, and/or mechanical fastener, according to one embodiment.

The plurality of thirds 906 may be a division of the surface area of the base drip tray 702 into three equal and/or proportionally structured regions along the longitudinal axis of the base drip tray 702. The plurality of thirds 906 may include the front third 908, the middle third 910, and the rear third 912, according to one embodiment.

The front third 908 may be the forward-most section of the base drip tray 702 when the apparatus is oriented in a typical user-facing configuration, according to one embodiment. The front third 908 may serve as an open surface area in front of the soap-holding structure. The front third 908 may remain unobstructed to promote user access, according to one embodiment.

The middle third 910 may be a central portion of the base drip tray 702 located between the front third 908 and the rear third 912, according to one embodiment.

The rear third 912 may be the backmost portion of the base drip tray 702 and may serve as a mounting place for the angled lower end 904 of the angled post 902. The rear third 912 may be adjacent to and/or aligned with the outermost edge 914 of the base drip tray 702, according to one embodiment.

The outermost edge 914 may be the circumferential boundary and/or peripheral edge of the base drip tray 702. The outermost edge 914 may encompass the full perimeter of the base drip tray 702, and may comprise various shapes including but not limited to circular, oval, and/or square form. The outermost edge 914 may form a continuous enclosing border around the base drip tray 702 of the soap holding apparatus 900, according to one embodiment.

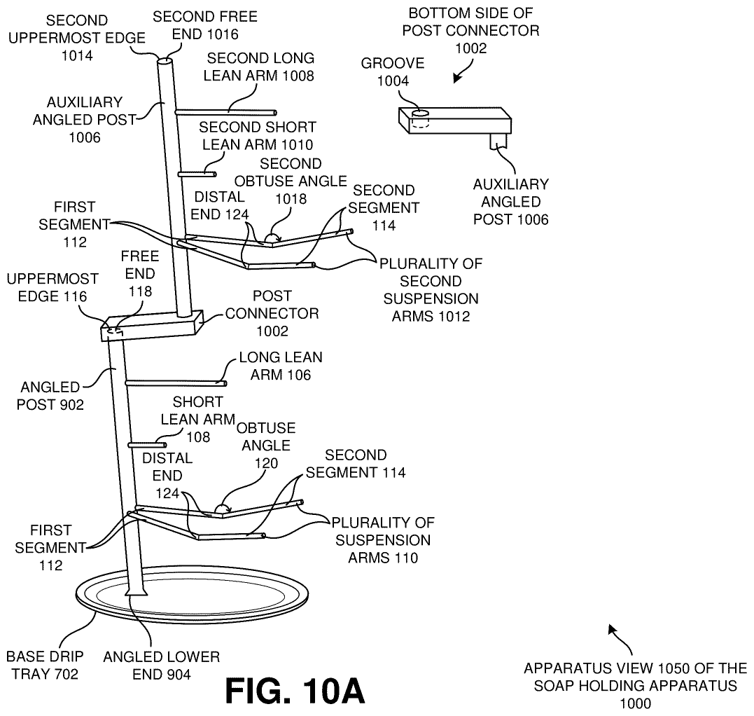

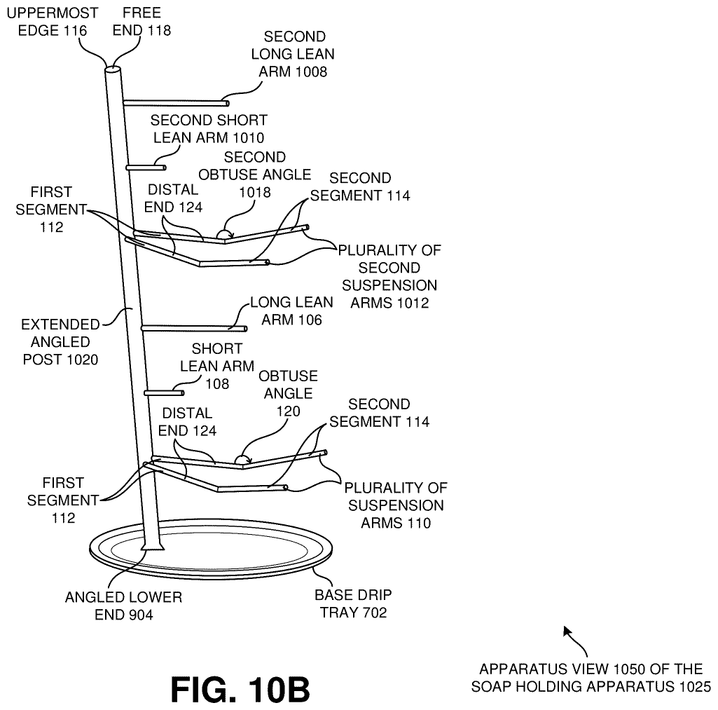

FIG. 10A-10B is an apparatus view 1050 of a soap holding apparatus 1000, according to one or more embodiments. As shown in FIG. 10A-10B, the soap holding apparatus 1000 comprises the long lean arm 106, the short lean arm 108, the plurality of suspension arms 110, the first segment 112, the second segment 114, the uppermost edge 116, the free end 118, the obtuse angle 120, the distal end 124, the base drip tray 702, the angled post 902, the angled lower end 904, the plurality of thirds 906, the front third 908, the middle third 910, the rear third 912, the outermost edge 914, a post connector 1002, a groove 1004, an auxiliary angled post 1006, a second long lean arm 1008, a second short lean arm 1010, a plurality of second suspension arms 1012, a second uppermost edge 1014, a second free end 1016, a second obtuse angle 1018, and an extended angled post 1020, according to one embodiment.

The soap holding apparatus 1000 may be a modular, two-tiered structure that enables vertical expansion of previous embodiments, according to one embodiment. The angled post 902 may rise from the base drip tray 702 and may be joined to the auxiliary angled post 1006 via the post connector 1002. The auxiliary angled post 1006 may then extend vertically above the connector 1002 and support an upper tier of components to support a plurality of bars of soap simultaneously, according to one embodiment.

The post connector 1002 may be a connecting component mounted at the free end 118 of the angled post 902 to enable the attachment of the auxiliary angled post 1006 for vertical expansion, according to one embodiment.

The groove 1004 may be a recessed portion located on the bottom side of the post connector 1002. The groove 1004 may be shaped to receive the top end of the angled post 902 and/or secure in place, according to one embodiment.

The auxiliary angled post 1006 may be a second post structure mounted on top of the angled post 902 via the post connector 1002. The auxiliary angled post 1006 extends further upward and/or to support a second soap holding tier, according to one embodiment.

The second long lean arm 1008 may be a support arm that may be affixed to the auxiliary angled post 1006. The second long lean arm 1008 may comprise an end that extends substantially horizontally outward to support the upper part of the second bar of soap when the soap may be resting on the plurality of second suspension arms 110, according to one embodiment.

The second short lean arm 1010 may be a support arm that may be laterally affixed to the auxiliary angled post 1006. The second short lean arm 1010 may be connected to the auxiliary angled post 1006 at a variable height below the second long lean arm 1008 and/or above the second suspension arms 1012, according to one embodiment.

The plurality of second suspension arms 1012 may comprise a pair of elongated members that may be connected to the auxiliary angled post 1006. The plurality of second suspension arms 1012 may include a first segment 112, a second segment 114, a second obtuse angle 1018, and a distal end 122. The plurality of second suspension arms 1012 may attach to the auxiliary angled post 1006 at a variable height below the second short lean arm 1010 and/or above the post connector 1002, according to one embodiment.

The second uppermost edge 1014 may be the top edge and/or boundary of the auxiliary angled post 1006, according to one embodiment. The second free end 1016 may be a terminal and/or end of the auxiliary angled post 1006, which may be unattached to any other structure. The second free end 1016 may allow unobstructed air circulation around the bar of soap, according to one embodiment.

The second obtuse angle 1018 may be the angle formed between the first segment 112 and the second segment 114 of the second plurality of suspension arms 110. The second obtuse angle 1018 may range between 130 degrees and 180 degrees to hold the second soap bar in place, which may prevent the second soap bar from slipping off, and/or allow drainage of excess water, according to one embodiment.

The extended angled post 1020 may be an elongated structural member configured to extend obliquely upward from the base drip tray 702. The extended angled post 1020 may be formed as a single continuous piece for structural rigidity. The extended angled post 1020 may comprise the angled lower end 904, the uppermost edge 116, and the free end 118. The extended angled post 1020 may be configured to support multiple tiers of soap-holding elements. The elements may include, but are not limited to, the long lean arm 106, the short lean arm 108, the second long lean arm 1008, the second short lean arm 1010, the plurality of suspension arms 110, and the plurality of second suspension arms 1012, according to one embodiment. Each of these arms may be affixed to the extended angled post 1020 at designated heights to accommodate separate soap bars on the lower and upper levels. The extended angled post 1020 may be constructed from various materials, including but not limited to plastic, stainless steel, aluminum, bamboo, wood, ceramic, and/or composite materials, according to one embodiment.

According to one or more embodiments, FIG. 10A shows the soap holding apparatus 1000 comprising the angled post 902 may be affixed to the base drip tray 702 at the angled lower end 904 and/or may extend obliquely upward to provide structural elevation. The long lean arm 106 and short lean arm 108 may extend laterally from the angled post 902 to support the upper and middle sections of a soap bar. Below the short lean arm 108, the plurality of suspension arms 110 may be mounted on the angled post 902 and may extend horizontally via first segment 112, transitioning to an upward bend via second segment 114 at the distal end 124. The second segment 114 may be angled at the obtuse angle 120 relative to the first segment 112, allowing the soap bar to rest securely without slippage.

Mounted atop the angled post 902 at the free end 118 may be a post connector 1002, configured with a groove 1004 on its bottom side. The groove 1004 may receive and/or seat the uppermost end of the angled post 902. The auxiliary angled post 1006 may be inserted vertically into the post connector 1002 to create a modular two-tier vertical structure. The auxiliary angled post 1006 may comprise the second uppermost edge 1014 and the second free end 1018. Attached to the auxiliary angled post 1006 may be the second long lean arm 1008 and the second short lean arm 1010. The second plurality of suspension arms 1012 may be affixed to the auxiliary angled post 1006 and may comprise the first segment 112, the second segment 114, the distal end 124, and the second obtuse angle 1018. The stacked configuration may allow for two separate soap bars to be suspended on different tiers of the soap holding apparatus 1000, supported independently by two sets of the long lean arm 106, the short lean arm 108, the plurality of suspension arms 110, the second long lean arm 1008, the second short lean arm 1010, and the plurality of second suspension arm 1012. The base drip tray 702 may collect water runoff from both levels and may provide support for the entire assembly.

In another embodiment shown in FIG. 10B, the extended angled post 1020 may be a single, continuous structural element. The extended angled post 1020 may extend from the angled lower end at the base drip tray 702 to the free end 118. The integrated structure of the extended angled post 1020 may support two tiers of soap-holding components on a single post. The lower tier of the extended angled post 1020 may comprise the long lean arm 106, the short lean arm 108, and the plurality of suspension arms 110. The upper tier of the extended angled post 1020 may be positioned above the lower tier, may comprise the second long lean arm 1008, the second short lean arm 1010, and the plurality of second suspension arms 1012. The extended angled post 1020 configuration may allow the soap holding apparatus 1000 to hold two bars of soap simultaneously in a vertically stacked arrangement, maximizing space while maintaining stability.

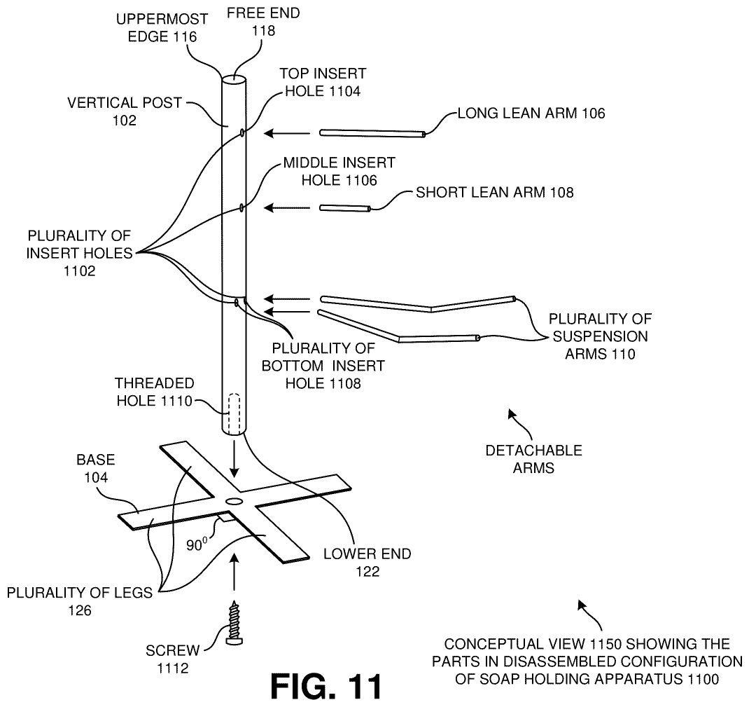

FIG. 11 is a conceptual view 1150 of a soap holding apparatus 1100, according to one embodiment. FIG. 11 illustrates the vertical post 102, the base 104, the long lean arm 106, the short lean arm 108, the plurality of suspension arms 110, the uppermost edge 116, the free end 118, the lower end 122, the plurality of legs 126, a plurality of insert holes 1102, a top insert hole 1104, a middle insert hole 1106, a plurality of bottom insert holes 1108, a threaded hole 1110, and a screw 1112, according to one embodiment.

The soap holding apparatus 1100 may may comprise an arrangement of various components that may be designed to hold the soap bar while allowing air circulation for drying, according to one embodiment.

The plurality of insert holes 1102 may be a series of openings located along the vertical post 102. The plurality of holes 1102 may comprise the top insert hole 1104, the middle insert hole 1106, and the plurality of bottom insert holes 1108. The plurality of holes 1102 may be configured to receive and/or secure a plurality of detachable arms comprising the long lean arm 106, the short lean arm 108, and/or the plurality of suspension arms 110 of the soap holding apparatus 1100, according to one embodiment.

The top insert hole 1104 may be a hole positioned towards the upper part of the vertical post 102. The top insert hole 1104 may be configured to accommodate the long lean arm 106, according to one embodiment. The middle insert hole 1106 may be a hole positioned below the top insert hole 1104 of the vertical post 102. The middle insert hole 1106 may be configured to accommodate the short lean arm 108, according to one embodiment.

The plurality of bottom insert holes 1108 may be a set of holes situated below the middle insert hole 1106 of the vertical post 102. The plurality of bottom insert holes 1108 may be configured to attach the plurality of suspension arms 110, according to one embodiment. The threaded hole 1110 may be an opening positioned at the lower end 122 of the vertical post 102 to allow the screw 1112 to be securely fastened the base 104 to the vertical post 102, according to one embodiment. The screw 1112 may be a fastener utilized to attach the base 104 to the lower end 122 of the vertical post 102 by engaging with the threaded hole 1110, according to one embodiment.

As shown in FIG. 11, the vertical post 102 may comprise the plurality of insert holes 1102 at various heights to accommodate the detachable arms (e.g. the long lean arm 106, the short lean arm 108, and/or the plurality of suspension arms 110). The long lean arm 106 may be inserted into the top insert hole 1104. The short lean arm 108 may be inserted into the middle insert hole 1106, positioned below the long lean arm 106. The plurality of suspension arms 110 may be inserted into the plurality of bottom insert holes 1108, located below the short lean arm 108. The arrangements of the plurality of insert holes 1102 may allow assembly and/or disassembly of the long lean arm 106, the short lean arm 108, and the plurality of suspension arms 110. The base 104 may comprise the plurality of legs 126, the plurality of legs 126 may be attached to the lower end 122 of the vertical post 102. The threaded hole 1110 at the lower end 122 of the vertical post 102 may align with a hole in the center of the base 104, allowing the screw 1112 to secure the two components together, providing a stable foundation for the soap holding apparatus 1100.

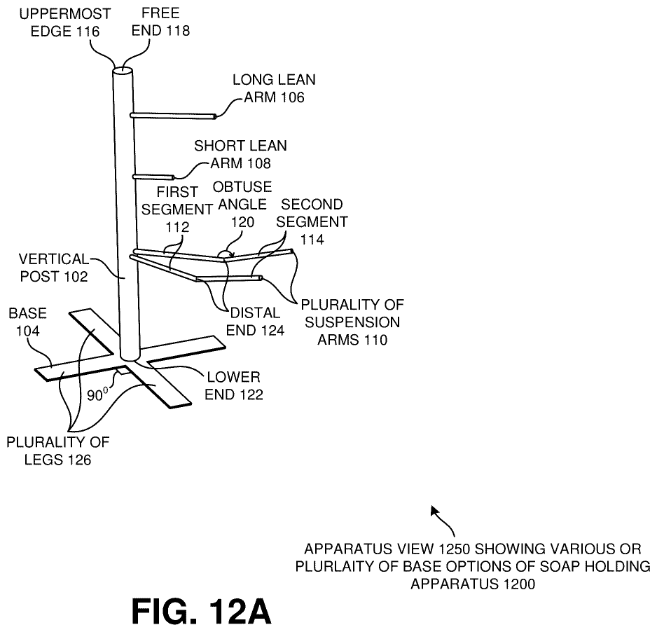

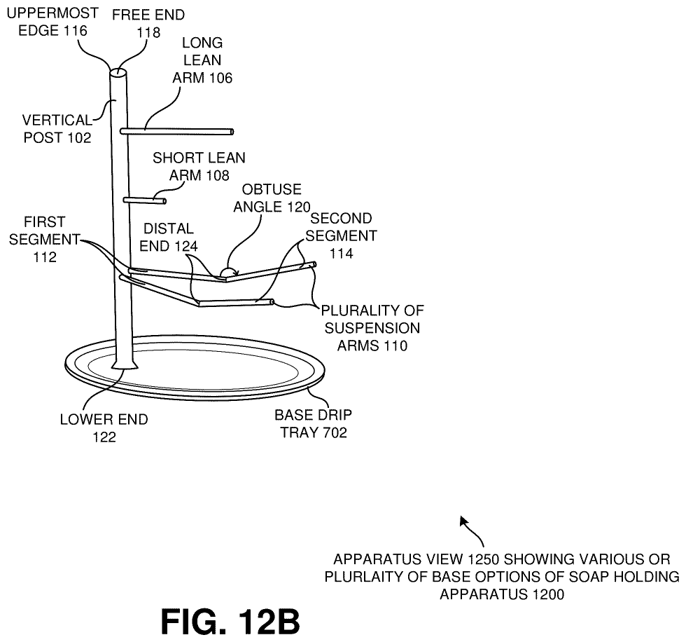

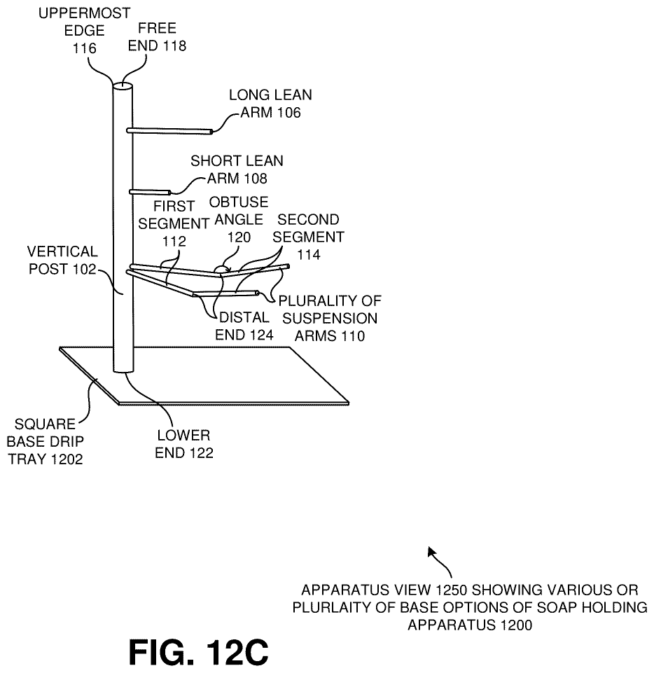

FIGS. 12A-12B-12C are apparatus views 1250 showing a plurality of base options of the soap holding apparatus 1200, according to one embodiment. FIGS. 12A-12B-12C illustrate the vertical post 102, the base 104, the long lean arm 106, the short lean arm 108, the plurality of suspension arms 110, the first segment 112, the second segment 114, the uppermost edge 116, the free end 118, the obtuse angle 120, the lower end 122, the distal end 124, the plurality of legs 126, the base drip tray 702, and a square base drip tray 1202, according to one embodiment.

The soap holding apparatus 1200 may comprise an arrangement of various components that may be designed to hold the soap bar while allowing air circulation for drying. The soap holding apparatus 1200 may comprise the a square base drip tray 1202, according to one embodiment.

The square base drip tray 1202 may be a quadrilateral-shaped structure which may function as the base support for the soap holding apparatus 1200. The square base drip tray 1202 may comprise a square and/or nearly square footprint designed to increase contact area with flat surfaces, including but not limited to countertops, corners, and/or shower ledges. The square base drip tray 1202 may be located at the lower end 122 of the vertical post 102 and may attach to the vertical post 102 using various means including but not limited to a snap-fit mechanism, adhesive bonding, threaded attachment, groove-and-slot locking mechanism, and/or molded as a single piece with the vertical post 102. The square base drip tray 1202 may comprise a shallow concave surface and/or a raised perimeter configured to retain residual water and/or soap drippings. The square base drip tray 1202 may be manufactured from a range of materials including but not limited to plastic, stainless steel, aluminum, ceramic, bamboo, or composite materials that are water-resistant and corrosion-resistant, according to one embodiment.

According to one or more embodiments, FIG. 12A illustrates the soap holding apparatus 1200 in a freestanding configuration. The vertical post 102 may extend upward from the base 104, the base 104 may be supported by a plurality of legs 126. The base 104 may provide stable support on a flat surface including but not limited to countertop and/or sink ledge to distribute the weight of the soap holding apparatus 1200 and the soap bar evenly to prevent tipping.

According to one or more embodiments, FIG. 12B illustrates the soap holding apparatus 1200 with the base drip tray 702 configuration. The lower end 122 of the vertical post 102 may be affixed to the round base drip tray 702. The round base drip tray 702 may serve a dual purpose, the round base drip tray 702 may provide a stable foundation for the apparatus and/or simultaneously collect any water and/or soap residue drip from the bar of soap resting on the plurality of suspension arms 110.

According to one or more embodiments, FIG. 12C illustrates the soap holding apparatus 1200 comprising the square base drip tray 1202 configuration. The vertical post 102 may be attached to the square base drip tray 1202 at its lower end 122. The square base drip tray 1202 may provide stability and/or collect dripping water. The geometric shape of the square base drip tray 1202 may provide both stability for the vertical post 102 and a tray to collect dripping water and/or soap residue.

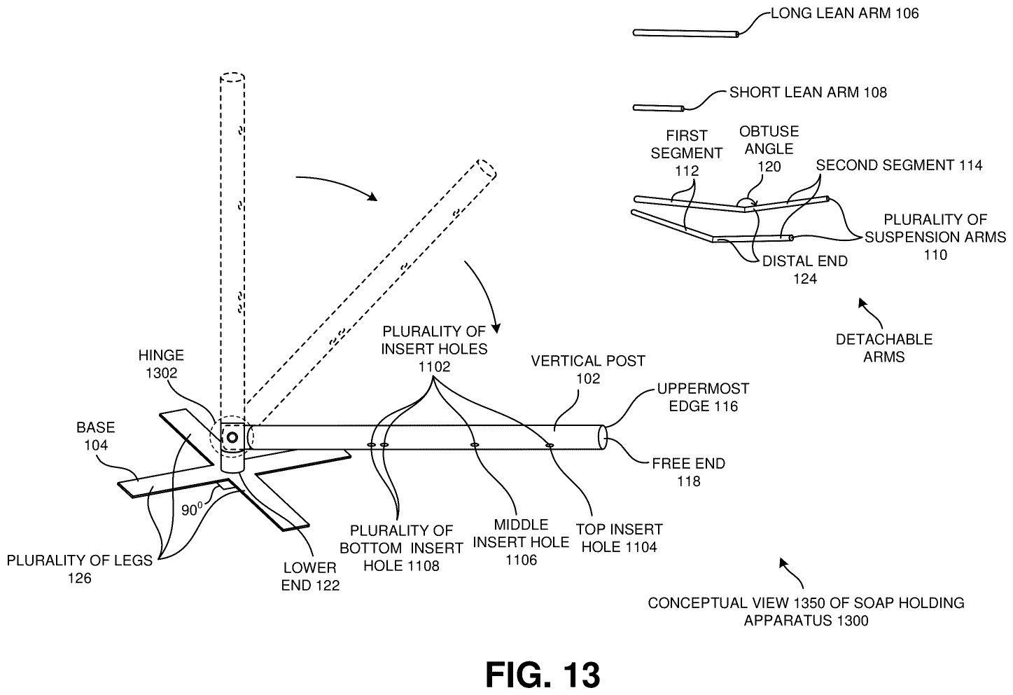

FIG. 13 is a conceptual view 1350 of the soap holding apparatus 1300, according to one embodiment. FIG. 13 illustrates the vertical post 102, the base 104, the long lean arm 106, the short lean arm 108, the plurality of suspension arms 110, the first segment 112, the second segment 114, the uppermost edge 116, the free end 118, the obtuse angle 120, the lower end 122, the distal end 124, the plurality of legs 126, the plurality of insert holes 1102, the top insert hole 1104, the middle insert hole 1106, the plurality of bottom insert holes 1108, and a hinge 1302, according to one embodiment.

The soap holding apparatus 1300 may comprise an arrangement of various components that may be designed to hold the soap bar while allowing air circulation for drying. The soap holding apparatus 1300 may comprise the hinge 1302 mechanism, according to one embodiment.

The hinge 1302 may be a joint configured to pivotally connect the base 104 of the soap holding apparatus 1300 to the vertical post 102 of the soap holding apparatus 1300 which may enable angular movement between the connected components. The hinge 1302 may include a plurality of configurations including but not limited butt hinge, living hinge, barrel hinge, piano hinge, friction hinge, detent hinge, and/or pivot hinge. The hinge 1302 may allow a rotation range between 0 degrees to approximately 90 degrees and/or more. The hinge 1302 may be constructed using materials including but not limited to stainless steel, brass, aluminum, high-strength polymer, and/or corrosion-resistant composite. The hinge 1302 may incorporate friction pads, detents, or a ratcheting mechanism to lock the hinge in predefined positions to maintain the angle between connected arms during use. The use of the hinge 1302 may enable the soap holding apparatus 1300 to fold flat for compact storage and/or allow adaptive positioning for optimal drainage, reach, and/or user preference, according to one embodiment.

As shown in FIG. 13, the soap holding apparatus 1300 may be configured with a pivoting mechanism (e.g. the hinge 1302) to allow the vertical post 102 to be folded downward, according to one embodiment. The hinge 1302 may facilitate the transformation of the soap holding apparatus 1300 from an operational state to a collapsed state. The hinge 1302 may be integrated at a connection point between the base 104 and the lower end 122 of the vertical post 102. The hinge 1302 may allow the vertical post 102 to pivot from a standard upright position to a folded horizontal position. The vertical post 102 may comprise the plurality of insert holes 1102, the plurality of insert holes 1102 comprises the top insert hole 1104, the middle insert hole 1106, and the plurality of bottom insert holes 1108. The long lean arm 106, the short lean arm 108, and the plurality of suspension arms 110 may be removed from the respective plurality of insert holes 1102. By detaching the arms and/or folding the vertical post 102 flat against the plane of the base 104, the soap holding apparatus 1300 may be reduced to a compact form for easy storage and/or transport.

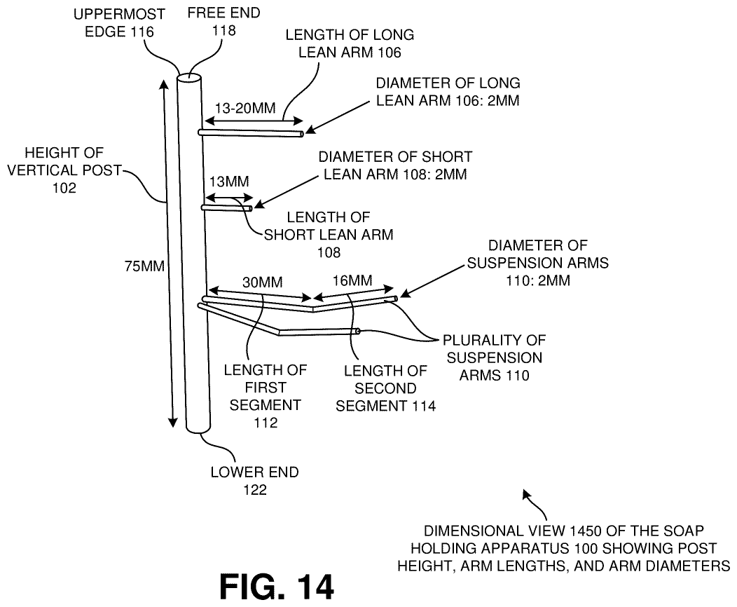

FIG. 14 is a dimensional view 1450 of the soap holding apparatus 100 showing vertical post 102 height, the length of a plurality of arms, and the diameter of the plurality of arms, according to one embodiment. FIG. 14 illustrates the vertical post 102, the base 104, the long lean arm 106, the short lean arm 108, the plurality of suspension arms 110, the first segment 112, the second segment 114, the uppermost edge 116, the free end 118, the obtuse angle 120, the lower end 122, and the distal end 124, according to one embodiment.

As shown in FIG. 14, the soap holding apparatus 100 may provide preferred measurements for key components of the soap holder, supporting manufacturability and ergonomic design:
The vertical post 102: 75 mm in height
The long lean arm 106: 13-20 mm in length
The short lean arm 108:˜13 mm in length, ideally equal to and/or slightly less than the long lean arm
The suspension arm 110—First segment 112: 30 mm in length
Base suspension arm 110—Second segment 114: 16 mm in length, upwardly angled
Diameter of the plurality of arms: 2 mm, round cross-section for strength and minimal contact. The dimensional profile may support ergonomic handling and optimal soap placement while minimizing water retention and/or maximizing drying.

The 75 mm height of the vertical post 102 may allow for stacked placement of support arms, including the long lean arm 106, the short lean arm 108, and the plurality of suspension arms 110, facilitating the holding of multiple soap bar sizes at varying elevations. The proportional spacing between the long lean arm 106, the short lean arm 108, the plurality of suspension arms 110, and spacing between the first segment 112 and the segment 114 may support a wide range of bar geometries. The 2 mm dimensional profile may support ergonomic handling and optimal soap placement while minimizing water retention and/or maximizing drying, according to one embodiment.

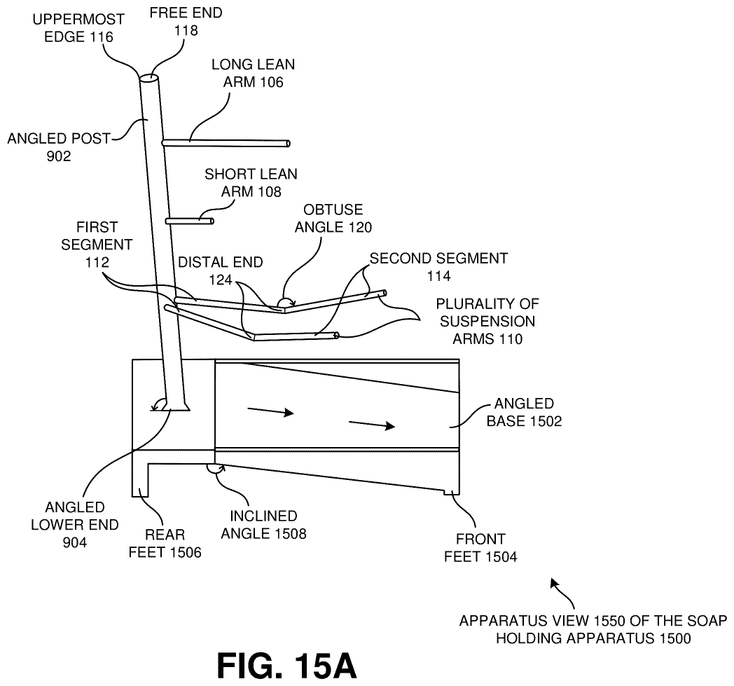

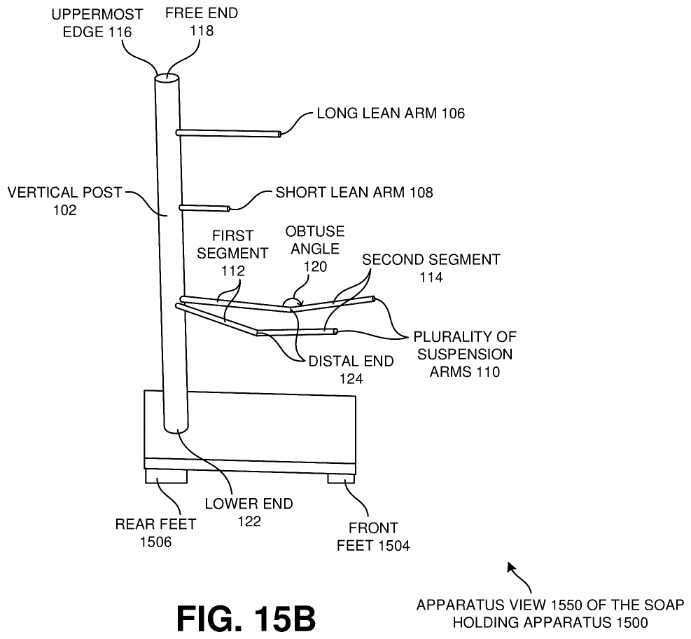

FIG. 15A-15B is an apparatus view 1550 of a soap holding apparatus 1500, according to one embodiment. FIG. 15 illustrates the long lean arm 106, the short lean arm 108, the plurality of suspension arms 110, the first segment 112, the second segment 114, the uppermost edge 116, the free end 118, the obtuse angle 120, the distal end 124, the angled post 902, the angled lower end 904, an angled base 1502, a front feet 1504, a rear feet 1506, an inclined angled 1508, and an inclined footed base 1510, according to one embodiment.

The soap holding apparatus 1500 may comprise an arrangement of various components that may be designed to hold the soap bar while allowing air circulation for drying. The soap holding apparatus 1500 may incorporate the angled base 1502, the front feet 1504, the rear feet 1506, the inclined angled 1508, and the inclined footed base 1510, according to one embodiment.

The soap holding apparatus 1500 may be a solid and/or semi-hollow support surface configured to rest on a flat counter, sink ledge, and/or any horizontal platform. The angled base 1502 may slope downward from the rear toward the front of the apparatus and may comprise a bend and/or downward tilt to facilitate gravitational flow of excess water away from the plurality of suspension arms 110. The angled base 1502 may be integrated with and/or removably attached to the angled post 902, according to one embodiment.

The front feet 1504 may be a shorter stabilizing member positioned at the front of the angled base 1502. The front feet 1504 may stabilize the angled base 1502 in a slanted orientation, according to one embodiment.

The rear feet 1506 may be elongated vertical support integrated at the posterior of the angled base 1502. The rear feet 1506 may be longer than the front feet 1504, creating the height differential to achieve the inclined angle 1508. The rear feet 1506 may provide structural elevation, tipping the apparatus forward to direct water flow, according to one embodiment.

The inclined angled 1508 may be an angular orientation of the angled base 1502 with respect to the horizontal plane. The inclined angled 1508 may range between 5 degrees and 30 degrees, providing tilt to guide water away from the soap contact zone, reducing moisture retention, and/or promoting hygiene and bar longevity. The inclined angle 1508 may be achieved via geometry, base molding, and/or height differential of supporting feet, according to one embodiment.

The inclined footed base 1510 may be a planar support platform and may rest directly upon a countertop, sink ledge, and/or other flat surface. The inclined footed base 1510 may comprise an angular tilt through differential leg elevation between the front feet 1504 and the rear feet 1506. The inclined structure may range between 5 to 20 degrees of slope. The base may be flat, molded, and/or fabricated from various materials, including but not limited to plastic, composite resin, bamboo, wood, ceramic, and/or stainless steel, according to one embodiment.

According to one or more embodiments, FIG. 15A illustrates the soap holding apparatus 1500 may comprise an angled structure designed to optimize water flow and/or structural efficiency. The angled post 902 may be affixed to the angled base 1502 at an angle of approximately 10 degrees from vertical, leaning rearward toward the back of the angled base 1502. The angled post 902 may be attached to the angled base 1502 via a plurality of methods, including but not limited to adhesive bonding, snap-fit engagement, threaded fasteners, groove-and-tab integration, and/or molding as a single piece.

The rearward tilt of the angled post 902 may complement the forward slant of the angled base 1502 to balance the overall center of gravity of the soap holding apparatus 1500. The opposing geometry may enhance the structural stability of the soap holding apparatus 1500 while directing excess water away from the plurality of suspension arms 110. The angular configuration of the angled post 902 and the angled base may create an ergonomic profile for placing and/or removing the bar of soap.

The angled base 1502 may comprise a downward slope from back to front, establishing the inclined angle 1508. The rear feet 1506 may be longer than the front feet 1504, and may elevate the posterior portion of the base, creating a gravitational bias to promote forward drainage. The inclined angle 1508 may range between 5 degrees and 30 degrees to optimize the flow of water drainage. The arrangement of the angled post 902, the long lean arm 106, the short lean arm 108, the plurality of suspension arms 110, and the angled base 1502 may form an integrated water-diverting structure. Excess water from a freshly used soap bar may drip onto the angled base 1502, where gravity may guide the water forward and away from the angled post 902. The soap holding apparatus 1500 may be placed on any horizontal surface, including but not limited to bathroom countertops, kitchen sinks, and/or shower ledges.

According to one or more embodiments, FIG. 15B illustrates the inclined footed base 1510 may be a set of the rear feet 1506 and the front feet 1504. The rear feet 1506 may be longer than the front feet 1504. The elevation difference may create a forward slope to establish an inclined plane relative to the horizontal surface beneath. Inclination may direct excess moisture and/or water runoff away from the soap contact area for faster drying and/or soap degradation. The inclination of the inclined footed base 1510 may be formed by the rear-to-front height differential and/or may range between 5 degrees and 20 degrees of angular slope. The angular design may be calibrated to promote gravity-assisted water displacement without destabilizing the soap holding apparatus 1500.

The vertical post 102 may be attached to the top surface of the inclined footed base 1510 via one or more means including but not limited to threaded connectors, bonding agents, snap-fit mechanisms, socket joints, and/or molding as an integrated single piece. Configuration of the inclined footed base 1510 may securely support the bar of soap while allowing for water to drain forward due to the slope of the inclined footed base 1510.

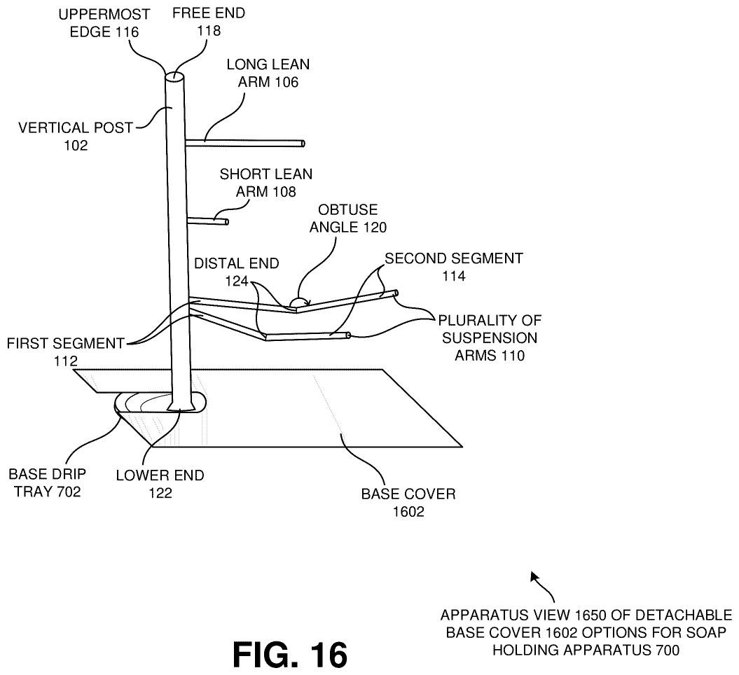

FIG. 16 is an apparatus view 1650 of the soap holding apparatus 700, according to one embodiment. FIG. 16 illustrates the vertical post 102, the base 104, the long lean arm 106, the short lean arm 108, the plurality of suspension arms 110, the first segment 112, the second segment 114, the uppermost edge 116, the free end 118, the obtuse angle 120, the lower end 122, the distal end 124, the plurality of legs 126, the base drip tray 702, and a base cover 1602, according to one embodiment.

The base cover 1602 may be a thin, flat panel dimensioned to conform to the upper surface of the base 104, the plurality of legs 126, the base drip tray 702, and/or the square base drip tray 1202. The base cover 1602 may be fabricated to rest over the base surface and/or below the plurality of suspension arms 110. The base cover 1602 may be removably attachable and/or friction-fitted to remain stable during use. The base cover 1602 may be constructed from moisture-resistant and/or easy-to-clean materials, including but not limited to plastic, silicone, composite rubber, stainless steel, and/or ceramic, according to one embodiment.

As shown in FIG. 16, the base cover 1602 may be a protective barrier over the base 104 of the soap holding apparatus 100-1500, to collect soap residue, water drips, and/or debris during the drying cycle of the soap bar. The removable design may enable the user to lift the cover from the base, rinse and wipe it clean, and/or reposition the base cover 1602 back into place. The base cover 1602 may include optional features including but not limited to raised edges, drainage slits, textured surfaces, and/or anti-slip ridges to improve water redirection and soap bar stability. The base cover 1602 may be magnetically attached and/or held in place by gravity alone. The modularity of the base cover 1602 may further allow for interchangeable customization of base surfaces, including different textures, colors, drainage patterns, and/or antimicrobial coatings. The incorporation of the base cover 1602 may reduce the frequency of deep cleaning required for the base 104 and/or the drip tray 702, promoting hygiene and/or maintenance convenience. By enabling fast removal and/or reinstallation, the base cover 1602 may provide a user-friendly enhancement for frequent sanitation without compromising the structural and/or aesthetic integrity of the soap holding apparatus 100-1500.

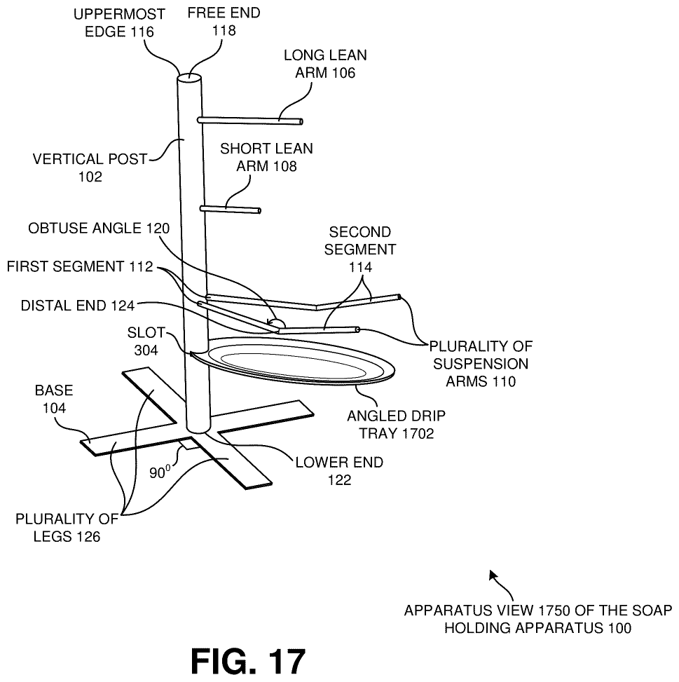

FIG. 17 is an apparatus view 1750 of the soap holding apparatus 100, according to one embodiment. FIG. 17 illustrates the vertical post 102, the base 104, the long lean arm 106, the short lean arm 108, the plurality of suspension arms 110, the first segment 112, the second segment 114, the uppermost edge 116, the free end 118, the obtuse angle 120, the lower end 122, the distal end 124, the plurality of legs 126, the slot 304, and an angled drip tray 1702, according to one embodiment.

The angled drip tray 1702 may be a removable and/or insertable component designed to collect water and soap residue that drips from the soap bar during storage or drying. The angled drip tray 1702 may slope in a forward direction and may be attached below the plurality of suspension arms 110. The angled orientation of the drip tray may promote the gravitational movement of collected liquid toward a lower front edge of the angled drip tray 1702. The slope may range between 5 degrees and 15 degrees, enabling efficient drainage and reducing the accumulation of residue within the tray. The angled drip tray 1702 may be constructed from water-resistant and/or corrosion-resistant materials including but not limited to plastic, stainless steel, ceramic, and/or composite polymer, according to one embodiment.

As shown in FIG. 17, the soap holding apparatus 100 may further comprise the angled drip tray 1702 that may be laterally affixed to a slot 304 on the vertical post 102 below the plurality of suspension arms 110. The angled drip tray 1702 may be attached and/or detached to the vertical post 102 by various means including but not limited to slide-in attachment, snap-on attachment, magnetic attachment, bracket and hook attachment, and/or twist-lock attachment. The slot 304 may be configured as an open-ended and/or enclosed receiving recess formed in the vertical post 102 and may be dimensioned to receive an edge, flange, and/or bracket feature formed along the angled drip tray 1702. The slot 304 may comprise frictional ridges, retention tabs, gloves, and/or locking mechanisms to securely seat the angled drip tray 1702 in place and prevent unintended detachment. The orientation of the slot 304 may be selected to optimize the forward tilt of the angled drip tray 1702.

The bar of soap may rest on the plurality of suspension arms 110 to allow any soap residual and/or moisture to drip freely downward into the angled drip tray 1702. The angled drip tray 1702 may protect the surrounding support surface (e.g., countertop and/or sink edge) from staining and/or accumulation of soap scum. The angled drip tray 1702 may provide hygienic and/or easy sanitation.

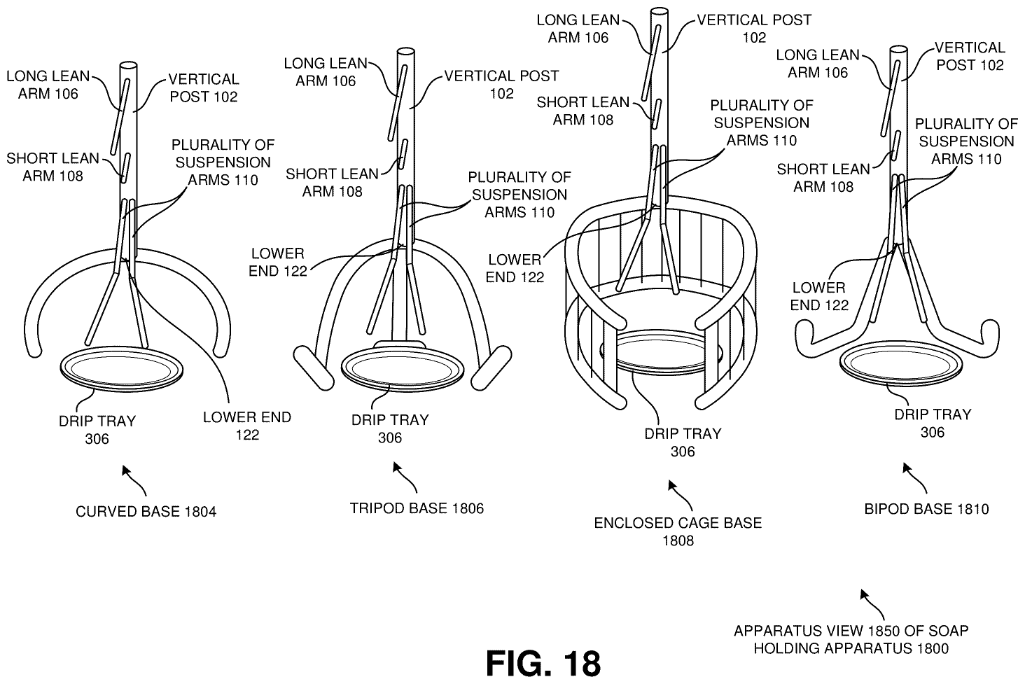

FIG. 18 is an apparatus view 1850 of the soap holding apparatus 1800 with a plurality of base options 1802, according to one embodiment. FIG. 18 illustrates the vertical post 102, the long lean arm 106, the short lean arm 108, the plurality of suspension arms 110, the first segment 112, the second segment 114, the uppermost edge 116, the free end 118, the obtuse angle 120, the lower end 122, the distal end 124, the drip tray 306, a plurality of base options 1802, a curved base 1804, a tripod base 1806, an enclosed cage base 1808, and a bipod base 1810, according to one embodiment.

The soap holding apparatus 1800 may comprise an arrangement of various components that may be designed to hold the soap bar while allowing air circulation for drying. The soap holding apparatus 1800 may allow for a plurality of base options 1802 to be interchangeably connected to the vertical post 102, according to one embodiment.

The plurality of base options 1802 may be interchangeable structural base configurations configured to support the vertical post 102 of the soap holding apparatus 1800. Each base option of the plurality of base options 1802 may be distinct in design to provide a discrete form of stability, surface adaptability, and/or aesthetic characteristics. The plurality of base options 1802 may comprise the curved base 1804, the tripod base 1806, the enclosed cage base 1808, and/or the bipod base 1810. Each base within the plurality of base options 1802 may be made from water-resistant and/or corrosion-resistant materials including but not limited to plastic, stainless steel, wood, ceramic, and/or composite polymer, according to one embodiment.

The curved base 1804 may comprise two arcuate leg members, the leg members extend symmetrically from the lower end 122 of the vertical post 102 and curve outward and downward to contact the underlying surface. The curved geometry may provide balanced weight distribution. The open curvature may allow for maximum air circulation around the base and/or the drip tray 306, according to one embodiment.

The tripod base 1806 may comprise three angularly spaced support legs projecting radially from the base of the vertical post 102. The tripod base 1806 configuration may provide tri-point stability for uneven surfaces including but not limited to bathroom countertops and/or natural stone. The tripod base 1806 design may reduce wobbling and/or tipping, while allowing visibility and access to the drip tray 306 beneath. Each leg may optionally include non-slip feet and/or caps to enhance grip on slippery surfaces, according to one embodiment.

The enclosed cage base 1808 may be configured with a plurality of vertical and horizontal members to encircle the lower portion of the soap holding apparatus 1800. The enclosed cage base 1808 may prevent the drip tray 306 from being dislodged and/or may serve as a barrier to prevent external contact and/or contaminants from entering the drip tray 306 area. The enclosed cage base 1808 may include access ports and/or detachable sections to allow for the drip tray removal and/or cleaning, according to one embodiment.

The bipod base 1810 may comprise two forward extending leg structures joined at the lower end 122 of the vertical post 102 and extending outward in opposite lateral directions. The bipod design may offer a minimalist alternative for stable support. Each leg of the bipod base 1810 may be flared, angled, and/or contoured for increased footprint and anti-tilt resistance, according to one embodiment.

As shown in FIG. 18, the soap holding apparatus 1800 may provide the plurality of base options 1802 to enable customization based on space availability, surface condition, structural preferences, and/or aesthetic style. The plurality of base options 1802 may be adapted to mount to a common vertical post 102 through the lower end 122, including but not limited to threading, socket fit, snap-on, twist lock, and/or molded connection. The plurality of base options 1802 may enable the soap holding apparatus 1800 to be used on, including but not limited to flat surfaces, sloped sink edges, small corner shelves, and/or textured materials without compromising balance and/or safety. The drip tray 306 may be positioned beneath the plurality of suspension arms 110 of the soap holding apparatus 1800.

In one embodiment, the curved base 1804 may be integrally molded and/or removably attached to the lower end 122 of the vertical post 102. The two arcuate leg members of the curved base 1804 may be fabricated as a continuous U-shaped structure and/or as two opposing segments joined at a central mount. The curved base 1804 may include built-in alignment notches and/or slots on the lower end 122 for orientation during assembly. In operation, the balanced curvature of the curved base 1804 may distribute the weight of the vertical post 102. The drip tray 306 may be positioned centrally within the interior arc formed by the two arcuate leg members of the curved base 1804. The curvature may provide an unobstructed region beneath the suspension arms 110, allowing the drip tray 306 to be freely positioned, inserted, and/or removed.

In another embodiment, the tripod base 1806 may be affixed to a central collar and/or hub structure. The hub may engage the lower end 122 of the vertical post 102 through an axial insertion, threaded screw-lock, and/or rotational bayonet mechanism. Each leg of the tripod base 1806 may be positioned equidistantly to maintain even load-bearing support. The tripod base 1806 geometry may provide enhanced support on both flat and/or uneven surfaces. The drip tray 306 may be centrally aligned between the leg members of the tripod base 1806, with open spaces between the legs allowing unimpeded placement, removal, and/or inspection of the drip tray 306.

In another embodiment, the enclosed cage base 1808 may comprise a plurality of interconnected vertical and horizontal members forming a perimeter structure to surround and/or secure the drip tray 306. The enclosed cage base 1808 may attach to the lower end 122 of the vertical post 102 via central coupling, ring bracket, and/or socket joint. The enclosed cage base 1808 may prevent the drip tray 306 from accidental displacement. The interior dimensions of the enclosed cage base 1808 may be shaped to snugly accommodate the drip tray 306 while allowing gravity-fed water collection and/or air circulation.

In another embodiment, the bipod base 1810 may be formed from two laterally extending leg structures. The bipod base 1810 may be removably attached to the lower end 122 of the vertical post 102. The bipod base 1810 may be affixed via a central collar, molded notch system, and/or mechanical bracket. The spacing between the two bipod legs may accommodate the drip tray 306 beneath the plurality of suspension arms 110. The open design of the bipod base 1810 may provide minimal obstruction and/or enable access to the drip tray 306 from the front or side.

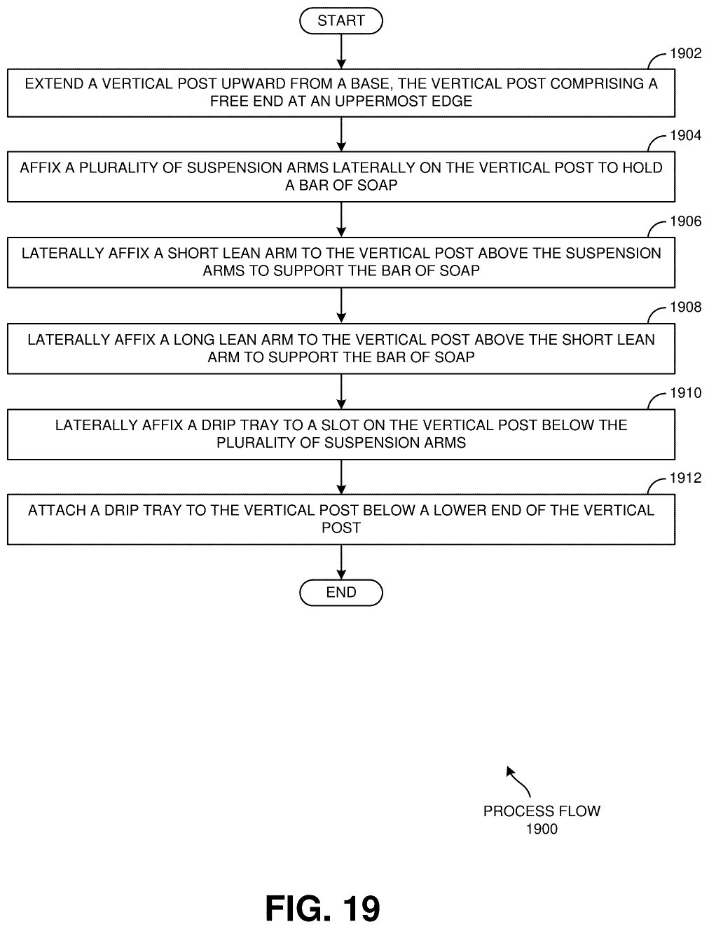

FIG. 19 is a process flow 1900 diagram describing a method of manufacturing the soap holding apparatuses of FIGS. 1-8, according to one embodiment.

In operation 1902, a vertical post 102 may be extended upward from a base 104, the vertical post 102 may comprise a free end 118 at an uppermost edge 116. In operation 1904, a plurality of suspension arms 110 may be affixed laterally on the vertical post 102 to hold a bar of soap. In operation 1906, a short lean arm 108 may be laterally affixed to the vertical post 102 above the suspension arms 110 to support the bar of soap. In operation 1908, a long lean arm 106 may be laterally affixed to the vertical post 102 above the short lean arm 108 to support the bar of soap. In operation 1910, a drip tray 306 may be laterally affixed to a slot 304 on the vertical post 102 below the plurality of suspension arms 110. In operation 1912, a drip tray 306 may be attached to the vertical post 102 below a lower end 122 of the vertical post 102.

A plain English example will now be described. Jim struggles with keeping soap dry and in place in the bathroom, according to one embodiment. The soap often ends up soggy and falls off the dish, making a mess and wasting soap, according to one embodiment. Jim found a solution in a soap holding apparatus that assists in drying the soap and holding the soap securely, according to one embodiment. The soap holding apparatus has a vertical post and a base which provide stability even when holding a large bar of soap, according to one embodiment. The vertical post is the central support with several arms designed to hold the different sizes of soap., according to one embodiment

A long lean arm extends horizontally from the vertical post and supports the upper part of a large bar of soap, keeping the large bar of soap elevated and away from any pooled water, according to one embodiment. This prevents the soap from becoming mushy and extends the soap's lifespan, according to one embodiment. Positioned at a variable height below the long lean arm, a short lean arm is affixed to the vertical post, according to one embodiment. The short lean arm is ideal for medium-sized soap, providing support to keep the soap in place, allowing the soap to dry quickly and evenly, according to one embodiment.

In addition to the long lean and short lean arms, the soap holding apparatus comprises suspension arms that securely hold the lower part of the bar of soap and a small bar of soap in place without slipping, according to one embodiment. The suspension arms accommodate the soap bar as it gets smaller with use, according to one embodiment. The suspension arms prevent the soap from sliding off and may ensure the soap dries efficiently, according to one embodiment. A drip tray is positioned underneath the suspension arms to catch any water or soap residue, keeping the bathroom countertop clean and dry, according to one embodiment. The drip tray is easy to detach and clean, according to one embodiment. The minimal contact area design of the soap holding apparatus minimizes or eliminates the soap from sticking to the holding arms once the soap dries, according to one embodiment. The minimal contact area simplifies the drying process and allows Jim to easily remove the soap from the soap holding apparatus with each use, according to one embodiment.

The soap holding apparatus is designed to be user-friendly making it easy for Jim to set up and use without any complicated steps, according to one embodiment. The design of the apparatus ensures that the arms are at an appropriate height reducing the need for bending or stretching, according to one embodiment. The apparatus is lightweight and portable, allowing Jim to easily move it from the sink to the shower or any other location, according to one embodiment. The drip tray can be easily adjusted or removed for cleaning or repositioning, according to one embodiment. The drainage design of the apparatus prevents soap from becoming slippery, making it easier for Jim to handle the soap during use, according to one embodiment. Jim can quickly place or remove soap from the apparatus, ensuring that the soap stays dry and ready for use with minimal effort, according to one embodiment.

Moreover, the soap holding apparatus is versatile and can be used in various settings, such as the sink area, bathtub, shower, or kitchen, according to one embodiment. Its compact and sturdy design allows Jim to move it easily from one location to another, adapting to different needs and spaces, according to one embodiment. Whether in the bathroom or any other area where soap is needed, the soap holding apparatus consistently keeps the soap dry and secure, according to one embodiment.

Over time, Jim notices that the soap lasts longer which saves Jim money and there is no more mess to clean up, which saves Jim time and effort, according to one embodiment. Jim finds that the soap-holding apparatus may make a significant difference in keeping the bathroom tidy and maintaining the soap in optimal condition for daily use, according to one embodiment.

Although the present embodiments have been described with reference to specific example embodiments, it will be evident that various modifications and changes may be made to these embodiments without departing from the broader spirit and scope of the various embodiments.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

1. A soap holding apparatus comprising:
an angled post comprising an angled lower end, an uppermost edge, and a free end, the angled post affixed to a base drip tray;
a plurality of suspension arms affixed laterally on the angled post to hold the bar of soap,
wherein each of the plurality of suspension arms is divided into two segments,
wherein each of the plurality of suspension arms comprises a first segment that laterally affixes each of the plurality of suspension arms to the angled post,
and
wherein each of the plurality of suspension arms comprises a second segment extending from a distal end of the first segment at an obtuse angle;
a short lean arm laterally affixed to the angled post above the suspension arms to support the bar of soap;
a long lean arm laterally affixed to the angled post above the short lean arm to support the bar of soap;

2. The soap holding apparatus of claim 1,
wherein the base drip tray is divided into a plurality of thirds, the plurality of thirds comprising a front third, a middle third, and a rear third,
wherein the angled post is affixed within the rear third of the base drip tray,
wherein the angled post is angled backward of the base drip tray, and
wherein the angled post is angled toward an outermost edge of the rear third of the base drip tray.

3. The soap holding apparatus of claim 1 further comprising:
an auxiliary angled post comprising a second uppermost edge and a second free end,
wherein the auxiliary angled post is connected to the angled post via a post connector, the post connector comprising a groove, the groove formed on a bottom side of the post connector,
wherein the groove is configured to securely attach to the free end of the angled post;
a plurality of second suspension arms laterally affixed to the auxiliary angled post,
wherein each of the plurality of second suspension arms is divided into two segments,
wherein each of the plurality of second suspension arms comprises a first segment that laterally affixes each of the plurality of second suspension arms to the auxiliary angled post,
and
wherein each of the plurality of second suspension arms comprises a second segment extending from a second distal end of the first segment at a second obtuse angle;
a second short lean arm laterally affixed to the auxiliary angled post above the plurality of second suspension arms; and
a second long lean arm laterally affixed to the auxiliary angled post above the second short lean arm.

4. A soap holding apparatus comprising:
an extended angled post extending from a the base drip tray,
a plurality of suspension arms affixed laterally on the extended angled post to hold a bar of soap,
wherein each of the plurality of suspension arms is divided into two segments,
wherein each of the plurality of suspension arms comprises a first segment that laterally affixes each of the plurality of suspension arms to the extended angled post,
and
wherein each of the plurality of suspension arms comprises a second segment extending from a distal end of the first segment at an obtuse angle;
a short lean arm laterally affixed to the extended angled post above the suspension arms to support the bar of soap;
a long lean arm laterally affixed to the extended angled post above the short lean arm to support the bar of soap;
a plurality of second suspension arms laterally affixed to the extended angled post,
wherein each of the plurality of second suspension arms is divided into two segments,
wherein each of the plurality of second suspension arms comprises a first segment that laterally affixes each of the plurality of suspension arms to the extended angled post,
and
wherein each of the plurality of suspension arms comprises a second segment extending from a second distal end of the first segment at a second obtuse angle;
a second short lean arm laterally affixed to the extended angled post above the plurality of second suspension arms;
and
a second long lean arm laterally affixed to the extended angled post above the second short lean arm.

5. The soap holding apparatus of claim 4,
wherein the base drip tray is divided into a plurality of thirds, the plurality of thirds comprises a front third, a middle third, and a rear third,
wherein the angled post is affixed within the rear third of the base drip tray,
wherein the angled post is angled backward of the base drip tray, and
wherein the angled post is angled toward an outermost edge of the rear third of the base drip tray.

6. The soap holding apparatus of claim 4, wherein the base comprises a plurality of legs extending outwardly from the lower end of the angled post to support the soap holding apparatus.

7. A soap holding apparatus comprising:
a vertical post comprising an uppermost edge, a free end, a lower end, a plurality of holes, and a threaded hole;
a base removably attached to the lower end of the vertical post;
a plurality of suspension arms removably attached to the vertical post to hold a bar of soap;
a short lean arm removably attached to the vertical post above the suspension arms to support the bar of soap; and
a long lean arm removably attached to the vertical post above the short lean arm to support the bar of soap.

8. The soap holding apparatus of claim 7, wherein the suspension arms, the long lean arm, and the short lean arm are removably attached to a plurality of insert holes, the plurality of holes comprising a top insert hole, a middle insert hole, and a plurality of bottom insert holes to affix the long lean arm, the short lean arm, and the plurality of suspension arms respectively.

9. The soap holding apparatus of claim 8, wherein the short lean arm, is removably attached to the top insert hole using at least one of friction, screw, and snap mechanism.

10. The soap holding apparatus of claim 8, wherein the long lean arm is removably attached to the middle insert hole using at least one of friction, screw and snap mechanism.

11. The soap holding apparatus of claim 8, wherein the plurality of suspension arms are removably attached to the plurality of bottom insert holes using at least one of friction, screw, and snap mechanism.

12. The soap holding apparatus of claim 7, wherein the base comprises a base drip tray to collect water dripping from the bar of soap when the bar of soap is held by the plurality of suspension arms.

13. The soap holding apparatus of claim 7, wherein the base comprises a plurality of legs extending outwardly to support the soap holding apparatus.

14. The soap apparatus of claim 7 wherein the base is removably attached to the vertical post by at least one of a screw, a peg-and-docket, a hook-and-loop, a screw-on mechanism, and a magnetic connection.

15. A soap holding apparatus comprising:
a vertical post extending from a base, the vertical post comprising a free end at an uppermost edge, and a lower end;
a hinge connecting the vertical post to the base;
a plurality of suspension arms removably attached to the vertical post to hold a bar of soap;
a short lean arm removably attached to the vertical post above the suspension arms to support the bar of soap; and
a long lean arm affixed detachably to the vertical post above the short lean arm to support the bar of soap.

16. The soap holding apparatus of claim 15, wherein the hinge allows the vertical post to pivot between upright and folded positions.

17. The soap holding apparatus of claim 15, wherein the hinge is configured to lock the vertical post in upright position.

18. The soap holding apparatus of claim 15, wherein the vertical post comprises a plurality of insert holes for attachment of the plurality of suspension arms, the short lean arm, and the long lean arm.

19. The soap holding apparatus of claim 15, wherein the base comprises a base drip tray to collect water dripping from the bar of soap when the bar of soap is held by the plurality of suspension arms.

20. The soap holding apparatus of claim 15, wherein the base comprises a plurality of legs extending outwardly to support the soap holding apparatus.
